(19) United States
(12) Patent Application Publication
(10) Pub. No.: US 2025/0280212 A1
(43) Pub. Date: Sep. 4, 2025

(54) PHOTOELECTRIC CONVERSION DEVICE AND CONTROL METHOD THEREOF

(71) Applicant: CANON KABUSHIKI KAISHA, Tokyo (JP)

(72) Inventor: SATOSHI KUMAKI, Saitama (JP)

(21) Appl. No.: 19/060,075

(22) Filed: Feb. 21, 2025

(30) Foreign Application Priority Data
Feb. 29, 2024 (JP) 2024-029691

(51) Int. Cl. H04N 25/78; H04N 25/62; H04N 25/772; H04N 25/779

(52) U.S. Cl. CPC H04N 25/78; H04N 25/62; H04N 25/772; H04N 25/779

(57) ABSTRACT

A clip transistor is switchable between a first operation and a second operation. In the first operation, a first voltage is supplied to a gate of the clip transistor in a first period in which a reset signal is converted from analog to digital and a second period in which a pixel signal is converted from analog to digital, and a second voltage higher than the first voltage is supplied to the gate of the clip transistor in a transfer period in which the transfer transistor is on. In the second operation, a third voltage higher than the first voltage is supplied to the gate of the clip transistor in the first period and the second period, and a fourth voltage higher than the second voltage and the third voltage is supplied to the gate of the clip transistor in the transfer period.

### BACKGROUND OF THE INVENTION

### Field of the Invention

The present disclosure relates to a photoelectric conversion device and a control method thereof.

### Description of the Related Art

Conventionally, an imaging device used in a digital camera, a smartphone, or the like includes a clip transistor for clipping an output of a pixel in order to reduce an influence on a peripheral portion when strong light is incident on a part of an imaging surface. An imaging device disclosed in Japanese Patent Application Laid-Open No. 2013-150115 can select whether to prioritize suppression of crosstalk or to prioritize maintenance of a dynamic range by switching a gate voltage of a reset transistor functioning as a clip transistor. Japanese Patent Application Laid-Open No. 2013-150115 describes a configuration in which a clip level is increased by increasing the gate voltage only during a conduction period of a transfer gate that transfers charges.

### SUMMARY OF THE INVENTION

However, in the imaging device disclosed in Japanese Patent Application Laid-Open No. 2013-150115, crosstalk is suppressed by increasing the clip level when charges are transferred, but image quality is degraded in some cases.

Therefore, an object of the present invention is to provide a photoelectric conversion device and a control method thereof capable of suppressing image quality degradation while suppressing crosstalk.

According to one aspect of the present specification, there is provided a photoelectric conversion device including: a plurality of pixels, each configured to include a photoelectric conversion unit that accumulates a charge according to incident light, an input node that holds the charge, a transfer transistor that transfers the charge from the photoelectric conversion unit to the input node, an amplification transistor that outputs a pixel signal based on the charge of the input node, and a clip transistor that clips voltage of the input node; and an AD conversion circuit configured to perform AD conversion of the pixel signal at the time of resetting the input node in a first period and perform AD conversion of the pixel signal based on the charge corresponding to the incident light in a second period, wherein the clip transistor is switchable between a first operation and a second operation, wherein in the first operation, a first voltage is supplied to a gate of the clip transistor in the first period and the second period, and a second voltage higher than the first voltage is supplied to the gate of the clip transistor in a transfer period in which the transfer transistor is on after the first period and before the second period, and wherein in the second operation, a third voltage higher than the first voltage is supplied to the gate of the clip transistor in the first period and the second period, and a fourth voltage higher than the second voltage and the third voltage is supplied to the gate of the clip transistor in the transfer period.

According to one aspect of the present specification, there is provided a control method of a photoelectric conversion device, wherein the photoelectric conversion device includes: a plurality of pixels, each configured to include a photoelectric conversion unit that accumulates a charge according to incident light, an input node that holds the charge, a transfer transistor that transfers the charge from the photoelectric conversion unit to the input node, an amplification transistor that outputs a pixel signal based on the charge of the input node, and a clip transistor that clips voltage of the input node; and an AD conversion circuit configured to perform AD conversion of the pixel signal at the time of resetting the input node in a first period and perform AD conversion of the pixel signal based on the charge corresponding to the incident light in a second period, wherein the control method comprises switching between a first operation and a second operation, wherein in the first operation, a first voltage is supplied to a gate of the clip transistor in the first period and the second period, and a second voltage higher than the first voltage is supplied to the gate of the clip transistor in a transfer period in which the transfer transistor is on after the first period and before the second period, and wherein in the second operation, a third voltage higher than the first voltage is supplied to the gate of the clip transistor in the first period and the second period, and a fourth voltage higher than the second voltage and the third voltage is supplied to the gate of the clip transistor in the transfer period.

Further features of the present invention will become apparent from the following description of exemplary embodiments with reference to the attached drawings.

### BRIEF DESCRIPTION OF THE DRAWINGS

FIG. 1 is a block diagram illustrating a schematic configuration of a photoelectric conversion device according to a first embodiment.

FIG. 2 is a circuit diagram illustrating a configuration example of a unit pixel according to the first embodiment.

FIG. 3 is a circuit diagram illustrating a configuration example of a buffer circuit according to the first embodiment.

FIG. 4 is a timing chart illustrating an operation example of the photoelectric conversion device in a high illuminance driving mode according to the first embodiment.

FIG. 5 is a timing chart illustrating an operation example of the photoelectric conversion device in a low illuminance driving mode according to the first embodiment.

FIG. 6 is a circuit diagram illustrating a configuration example of a unit pixel according to a second embodiment.

FIG. 7 is a circuit diagram illustrating a configuration example of a buffer circuit according to the second embodiment.

FIG. 8 is a timing chart illustrating an operation example of the photoelectric conversion device in a low-gain high illuminance driving mode according to the second embodiment.

FIG. 9 is a timing chart illustrating an operation example of the photoelectric conversion device in a low-gain low illuminance driving mode according to the second embodiment.

FIG. 10 is a timing chart illustrating an operation example of the photoelectric conversion device in a medium-gain high illuminance driving mode according to the second embodiment.

FIG. 11 is a timing chart illustrating an operation example of the photoelectric conversion device in a medium-gain low illuminance driving mode according to the second embodiment.

FIG. 12 is a timing chart illustrating an operation example of the photoelectric conversion device in a high-gain high illuminance driving mode according to the second embodiment.

FIG. 13 is a timing chart illustrating an operation example of the photoelectric conversion device in a high-gain low illuminance driving mode according to the second embodiment.

FIG. 14 is a block diagram illustrating a schematic configuration of an imaging system according to a third embodiment.

FIGS. 15A and 15B are diagrams illustrating configuration examples of an imaging system and a movable body according to a fourth embodiment.

FIG. 16 is a block diagram illustrating a schematic configuration of an equipment according to a fifth embodiment.

### DESCRIPTION OF THE EMBODIMENTS

Preferred embodiments of the present invention will now be described in detail in accordance with the accompanying drawings.

### First Embodiment

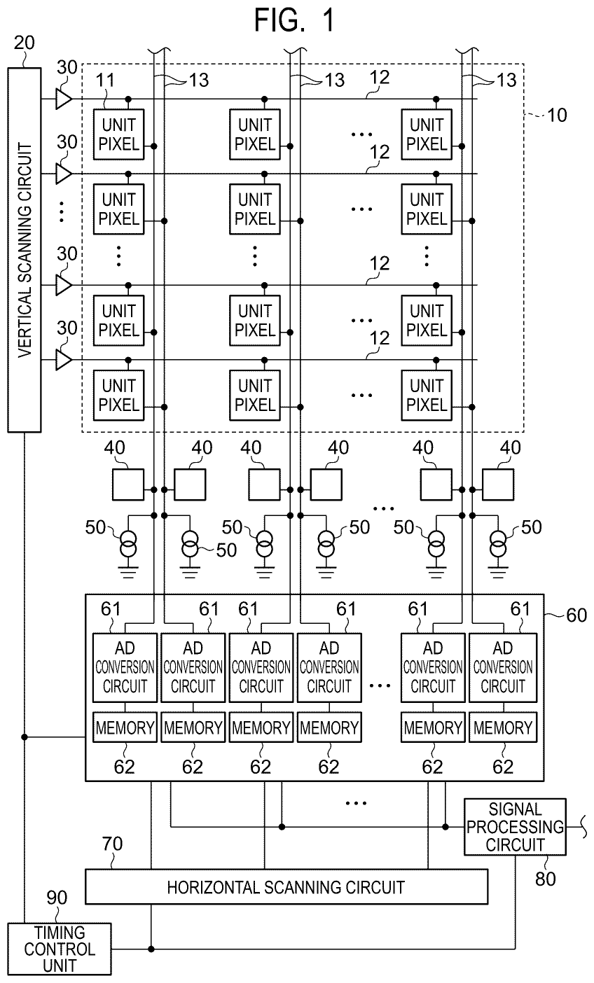

A photoelectric conversion device and a driving method thereof according to a first embodiment will be described with reference to FIGS. 1 to 5. First, a schematic configuration of the photoelectric conversion device according to the present embodiment will be described with reference to FIG. 1. FIG. 1 is a block diagram illustrating a schematic configuration of the photoelectric conversion device according to the present embodiment.

As illustrated in FIG. 1, the photoelectric conversion device according to the present embodiment includes a pixel unit 10, a vertical scanning circuit 20, a plurality of buffer circuits 30, and a plurality of column signal line clip circuits 40. The photoelectric conversion device further includes a plurality of current sources 50, an analog-to-digital (AD) conversion unit 60, a horizontal scanning circuit 70, a signal processing circuit 80, and a timing control unit 90.

The pixel unit 10 is provided with a plurality of unit pixels 11 arranged in an array so as to form a plurality of rows and a plurality of columns. The number of unit pixels 11 constituting the pixel unit 10 is not particularly limited. For example, the pixel unit 10 may include a plurality of unit pixels 11 arranged in an array of several thousand rows and several thousand columns as in a general digital camera. Alternatively, the pixel unit 10 may include a plurality of unit pixels 11 arranged in one row or one column. Alternatively, the pixel unit 10 may include one unit pixel 11.

In each row of the pixel array of the pixel unit 10, a control line 12 extends in a first direction (lateral direction in FIG. 1). The control lines 12 are connected to the unit pixels 11 arranged in the first direction, respectively, and form signal lines common to the unit pixels 11. The unit pixels 11 arranged in the same row are controlled by the same control line 12. Each of the control lines 12 may include a plurality of signal lines for supplying a plurality of types of control signals to the unit pixel 11. The control line 12 of each row is connected to the vertical scanning circuit 20.

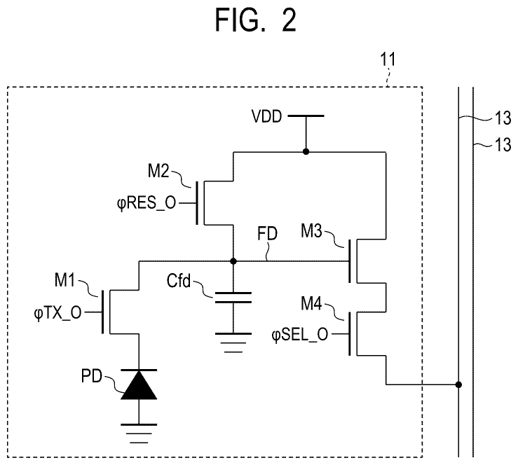

In each column of the pixel array of the pixel unit 10, a column signal line 13 extends in a second direction (vertical direction in FIG. 1) intersecting the first direction. The column signal lines 13 are connected to the unit pixels 11 arranged in the second direction, respectively, and are signal lines common to the unit pixels 11. A plurality of (for example, two) column signal lines 13 are arranged for each column. The unit pixels 11 in the even-numbered rows and the unit pixels 11 in the odd-numbered rows are connected to the same column signal line 13. Each of the column signal lines 13 may include a plurality of signal lines for transferring signals output from the unit pixels 11. The column signal line 13 of each column is connected to the AD conversion unit 60. Each unit pixel 11 converts incident light into an electrical signal, and outputs the converted electrical signal to the AD conversion unit 60 via the column signal line 13. More specifically, each unit pixel 11 outputs a pixel signal (hereinafter, referred to as a “reset signal”) before the charges generated by the photoelectric conversion unit are transferred and a pixel signal after the charges of the photoelectric conversion unit are transferred. The circuit configuration of the unit pixel 11 will be described later with reference to FIG. 2.

The vertical scanning circuit 20 receives a control signal output from the timing control unit 90, generates a control signal for driving the unit pixel 11, and supplies the control signal to the unit pixel 11 via the buffer circuit 30 and the control line 12. The vertical scanning circuit 20 may include a logic circuit such as a shift register or an address decoder. The vertical scanning circuit 20 sequentially scans the unit pixels 11 in the pixel unit 10 by two rows, and outputs pixel signals of the unit pixels 11 to the AD conversion unit 60 via the column signal lines 13. Thus, an image of one frame is acquired.

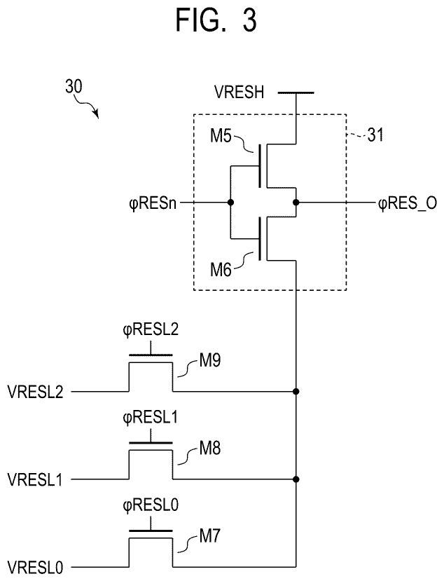

The plurality of buffer circuits 30 perform conversion between high level and low level of a signal in addition to a function of a circuit that amplifies a control signal output from the vertical scanning circuit 20. Each of the buffer circuits 30 is disposed for each control line 12. The buffer circuit 30 will be described later with reference to FIG. 3.

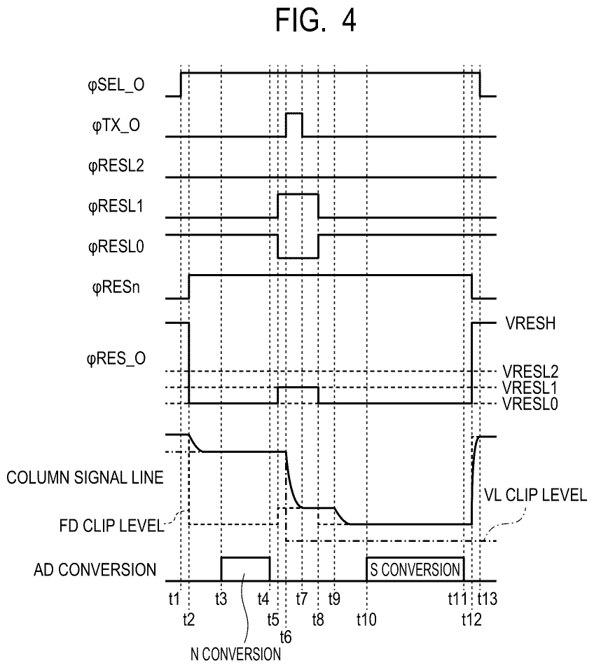

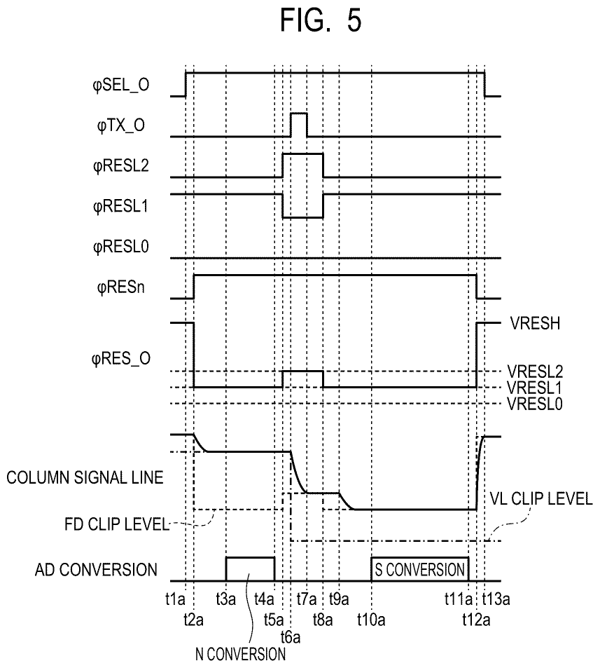

The plurality of column signal line clip circuits 40 limit an amplitude of the pixel signal transmitted to the column signal line 13 to a predetermined voltage (VL clip level). Each of the column signal line clip circuits 40 is disposed for each column signal line 13. The column signal line clip circuit 40 has a source follower amplifier, and when the voltage of the column signal line 13 by the unit pixel 11 is lower than the VL clip level based on the input voltage of the source follower amplifier, the current flows to the column signal line 13. As a result, the voltage of the column signal line 13 does not drop below the VL clip level. The VL clip level is controlled to a different voltage at the time of reading the reset signal and at the time of reading the pixel signal. The control of the VL clip level will be described later with reference to FIGS. 4 and 5.

The plurality of current sources 50 supplies a bias current. The current source 50 is disposed for each column signal line 13, and supplies the bias current to an amplification transistor M3 (source follower amplifier) described later of the unit pixel 11 via the column signal line 13.

The AD conversion unit 60 includes a plurality of AD conversion circuits 61 and a plurality of memories 62. Each of the AD conversion circuits 61 is disposed for each column signal line 13, and converts an analog signal (reset signal, pixel signal) supplied from the unit pixel 11 via the column signal line 13 into a digital signal. The AD conversion circuit 61 outputs the converted digital signal to the memory 62.

The plurality of memories 62 store digital signals. Each of the memories 62 is disposed for each AD conversion circuit 61. The memory 62 includes a plurality of unit memories, and stores the reset signal and the pixel signal converted by the AD conversion circuit 61.

The horizontal scanning circuit 70 receives a control signal output from the timing control unit 90 and outputs a signal stored in the memory 62. A logic circuit such as a shift register or an address decoder may be used as the horizontal scanning circuit 70. The horizontal scanning circuit 70 sequentially scans the memories 62, and outputs the reset signal and the pixel signal held in each of the memories 62 to the signal processing circuit 80.

The signal processing circuit 80 processes the digital signal. The signal processing circuit 80 subtracts the reset signal from the pixel signal, extracts only a signal corresponding to the amount of incident light, and outputs the extracted signal to the outside of the photoelectric conversion device.

The timing control unit 90 controls the operation and timing of the elements. The timing control unit 90 generates control signals for controlling the operations and timings of the vertical scanning circuit 20, the AD conversion unit 60, the horizontal scanning circuit 70, and the signal processing circuit 80, and supplies the generated control signals to the respective elements. The timing control unit 90 may include various electronic components such as a CPU and a memory.

Next, the configuration of the unit pixel 11 will be described with reference to FIG. 2. FIG. 2 is a circuit diagram illustrating a configuration example of the unit pixel 11 according to the present embodiment. The unit pixel 11 converts incident light into an electrical signal and outputs the electrical signal. The unit pixel 11 includes a photoelectric conversion element PD as a photoelectric conversion unit, a transfer transistor M1, a reset transistor M2, an amplification transistor M3, and a selection transistor M4.

The photoelectric conversion element PD is, for example, a photdiode that accumulates charges according to incident light. An anode of the photoelectric conversion element PD is connected to a ground node, and a cathode of the photoelectric conversion element PD is connected to a source of the transfer transistor M1. A drain of the transfer transistor M1 is connected to a source (first main node) of the reset transistor M2 and a gate of the amplification transistor M3. An input node FD is a node to which the drain of the transfer transistor M1, a source of the reset transistor M2, and the gate of the amplification transistor M3 are connected. The input node FD is a so-called floating diffusion portion. The floating diffusion portion includes a capacitance component (floating diffusion capacitance) and has a function as a charge holding portion that holds charge. The floating diffusion capacitance includes a PN junction capacitance, a wiring capacitance, and the like. The coefficient of charge-voltage conversion by the floating diffusion portion is determined by a capacitance Cfd such as a floating diffusion capacitance.

A drain (second main node) of the reset transistor M2 and a drain of the amplification transistor M3 are connected to a power supply voltage node (power supply voltage line) to which the voltage VDD is supplied. A source of the amplification transistor M3 is connected to a drain of the selection transistor M4. A source of the selection transistor M4 is connected to the column signal line 13.

In FIG. 2, the control line 12 of each row includes a signal line connected to a gate of the transfer transistor M1, a signal line connected to a gate of the reset transistor M2, and a signal line connected to a gate of the selection transistor M4. The plurality of unit pixels 11 in the same row are connected to a common signal line, and are simultaneously controlled by a common control signal.

A control signal φTX_O is supplied from the vertical scanning circuit 20 to the gate of the transfer transistor M1 via a buffer circuit (not illustrated). When the control signal φTX_O is at high level, the transfer transistor M1 is turned on, and when the control signal φTX_O is at low level, the transfer transistor M1 is turned off.

A control signal SEL_O is supplied from the vertical scanning circuit 20 to the gate of the selection transistor M4 via a buffer circuit (not illustrated). When the control signal φSEL_O is at high level, the selection transistor M4 is turned on, and when the control signal φSEL_O is at low level, the selection transistor M4 is turned off.

The gate of the reset transistor M2 is supplied with a control signal φRES_O from the vertical scanning circuit 20 via the buffer circuit 30. When the control signal φRES_O is at high level, the reset transistor M2 is turned on, and when the control signal φRES is at low level, the reset transistor M2 is turned off. Here, the reset transistor M2 can function as a clip transistor that clips voltage of the input node FD in accordance with the control signal φRES_O. That is, the control signal φRES_O can cause the reset transistor M2 to function as a clip transistor that limits an amplitude of the pixel signal at the FD clip level (clip level) corresponding to a gate voltage of the reset transistor M2.

The present embodiment will be described on the assumption that electrons among electron-hole pairs generated in the photoelectric conversion element PD by light incidence are used as signal charges. When electrons are used for signal charges, each transistor constituting the unit pixel 11 may be configured by an N-type MOS transistor. In this case, when a high-level control signal is supplied from the vertical scanning circuit 20, the corresponding transistor is turned on. When a low-level control signal is supplied from the vertical scanning circuit 20, the corresponding transistor is turned off. However, the signal charge is not limited to electrons, and holes may be used as the signal charge. In this case, the conductivity type of each transistor is opposite to that described in the present embodiment. The names of the source and the drain of the MOS transistor may vary depending on the conductivity type or the function of the transistor. Some or all of the names of the source and the drain used in the present embodiment may be referred to as reverse names.

The photoelectric conversion element PD converts (photoelectrically converts) the incident light into charges of an amount corresponding to the amount of the incident light. The transfer transistor M1 is turned on to transfer the charge held by the photoelectric conversion element PD to the input node FD. The charge transferred from the photoelectric conversion element PD is held in the capacitance (floating diffusion capacitance) of the input node FD. As a result, the input node FD becomes a potential corresponding to the amount of charge transferred from the photoelectric conversion element PD by charge-voltage conversion by the floating diffusion capacitance.

The selection transistor M4 is turned on or off, and selectively connects the unit pixel 11 of the row to be read out among the unit pixels 11 constituting the pixel unit 10 to the column signal line 13. When the selection transistor M4 is turned on, the amplification transistor M3 of the unit pixel 11 in the row to be read is electrically connected to the column signal line 13. The voltage VDD is supplied to the drain of the amplification transistor M3, and the bias current is supplied to the source from the current source 50 via the selection transistor M4. The amplification transistor M3 constitutes an amplification circuit (source follower circuit) whose gate is connected to the input node FD. The amplification transistor M3 outputs a signal based on a charge of the input node FD to the column signal line 13 via the selection transistor M4. In this sense, the amplification transistor M3 and the selection transistor M4 are an output unit that outputs a pixel signal according to an amount of charges held in the input node FD.

The reset transistor M2 supplies a voltage (voltage VDD) for resetting the input node FD (charge holding unit). The reset transistor M2 is turned on to reset the input node FD to a voltage corresponding to the voltage VDD. When the voltage of the input node FD becomes lower than a gate threshold voltage of the reset transistor M2 by the charge transferred from the photoelectric conversion element PD, the reset transistor M2 is turned on, and the charge of the input node FD is discharged to the power supply (voltage VDD). Since the discharge of the charges stops at a voltage that is lowered by a threshold voltage from the gate voltage of the reset transistor M2, the reset transistor M2 functions as a clip transistor that limits an amplitude at the FD clip level corresponding to the gate voltage.

As described above, the unit pixel 11 can sequentially output the reset signal based on the state in which the potential of the input node FD is reset by the reset transistor M2 and the pixel signal having the signal level based on the charge generated by the photoelectric conversion performed by the photoelectric conversion element PD.

The circuit configuration of the unit pixel 11 is not limited to the configuration illustrated in FIG. 2. For example, the selection transistor M4 may be connected between a power supply voltage node to which the voltage VDD is supplied and the amplification transistor M3. The circuit configuration illustrated in FIG. 2 is a so-called four-transistor type including a transfer transistor M1, a reset transistor M2, an amplification transistor M3, and a selection transistor M4, but is not limited thereto. For example, the selection transistor M4 may be omitted and be a circuit configuration of a three-transistor type in which the amplification transistor M3 also functions as a selection transistor. In addition, a circuit configuration having five or more transistors, in which the number of transistors is larger than that illustrated in FIG. 2, may be adopted.

Next, the configuration of the buffer circuit 30 will be described with reference to FIG. 3. FIG. 3 is a circuit diagram illustrating a configuration example of the buffer circuit 30 according to the present embodiment. The buffer circuit 30 not only functions as a circuit for amplifying the control signal output from the vertical scanning circuit 20, but also performs conversion between high level and low level of the signal. As illustrated in FIG. 3, the buffer circuit 30 includes an inverter 31 and transistors M7, M8, and M9.

The inverter 31 includes a P-type MOS transistor M5 and an N-type MOS transistor M6.

A gate of the P-type MOS transistor M5 is connected to the vertical scanning circuit 20, and receives a control signal φRESn from the vertical scanning circuit 20. The P-type MOS transistor M5 has a source connected to the power supply (voltage VRESH) and a drain connected to a drain of the N-type MOS transistor M6 and the gate of the reset transistor M2.

A gate of the N-type MOS transistor M6 is connected to the vertical scanning circuit 20, and receives a control signal φRESn from the vertical scanning circuit 20. The drain of the N-type MOS transistor M6 is connected to a drain of the P-type MOS transistor M5 and the gate of the reset transistor M2, and a source thereof is connected to sources of the transistors M7, M8, and M9.

A gate of the transistor M7 is connected to the vertical scanning circuit 20, and receives a control signal φRESL0 from the vertical scanning circuit 20. The transistor M7 has a drain connected to the power supply (voltage VRESL0) and a source connected to a source of the N-type MOS transistor M6 of the inverter 31. The transistor M7 is turned on when the high-level control signal φRESL0 is output, and supplies a voltage VRESL0 (for example, 0 V) to the inverter 31. The transistor M7 is turned off when the low-level control signal φRESL0 is output, and does not supply the voltage VRESL0 (for example, 0 V) to the inverter 31. The voltage VRESL0 is an example of a first voltage.

A gate of the transistor M8 is connected to the vertical scanning circuit 20, and receives a control signal φRESL1 from the vertical scanning circuit 20. A drain of the transistor M8 is connected to the power supply (voltage VRESL1), and a source thereof is connected to the source of the N-type MOS transistor M6 of the inverter 31. The transistor M8 is turned on when the high-level control signal φRESL1 is output, and supplies a voltage VRESL1 (for example, 0.6 V) to the inverter 31. The transistor M8 is turned off when the low-level control signal φRESL1 is output, and does not supply the voltage VRESL1 (for example, 0.6 V) to the inverter 31. The voltage VRESL1 is an example of a second voltage or a third voltage.

A gate of the transistor M9 is connected to the vertical scanning circuit 20, and receives a control signal φRESL2 from the vertical scanning circuit 20. A drain of the transistor M9 is connected to the power supply (voltage VRESL2), and a source thereof is connected to the source of the N-type MOS transistor M6 of the inverter 31. The transistor M9 is turned on when the high-level control signal φRESL2 is output, and supplies a voltage VRESL2 (for example, 1.2 V) to the inverter 31. The transistor M9 is turned off when the low-level control signal φRESL2 is output, and does not supply the voltage VRESL2 (for example, 1.2 V) to the inverter 31. The voltage VRESL2 is an example of a fourth voltage.

As described above, the buffer circuit 30 can switch low level of the inverter 31 in three stages (0 V, 0.6 V, and 1.2 V) by switching the control signals φRESL0, φRESL1, and φRESL2. In the buffer circuit 30, when the control signal φRESn output from the vertical scanning circuit 20 to the inverter 31 is at low level, the P-type MOS transistor M5 is turned on. Then, high level (voltage VRESH) is supplied to the reset transistor M2 as the control signal φRES_O. On the other hand, when the control signal φRESn output from the vertical scanning circuit 20 to the inverter 31 is at high level, the N-type MOS transistor M6 is turned on. Then, low level (Voltage of any one of the voltage VRESL0, the voltage VRESL1, and the voltage VRESL2) is supplied to the reset transistor M2 as the control signal φRES_O. In this way, the buffer circuit 30 performs logic inversion and amplification of the control signal φRESn by the inverter 31, and supplies the control signal φRES_O to the reset transistor M2 of each unit pixel 11.

Next, an operation example of the photoelectric conversion device will be described. The photoelectric conversion device has two operations: a high illuminance driving mode (first operation) that can be selected when illuminance is high; and a low illuminance driving mode (second operation) that can be selected when illuminance is low. The two operations may be selected at the time of imaging. In addition, the first operation and the second operation may be switched by control from an outside of the photoelectric conversion device, or may be switched by an internal control of the photoelectric conversion device. As the control in the photoelectric conversion device, for example, there is an operation in which after the photoelectric conversion device is operated in one of the first operation and the second operation, the photoelectric conversion device is switched to the other of the first operation and the second operation when the obtained signal level is not within a desired range. In addition, the first operation and the second operation may be periodically switched by the internal control of the photoelectric conversion device. First, the high illuminance driving mode will be described. FIG. 4 is a timing chart illustrating an operation example of the photoelectric conversion device in a high illuminance driving mode according to the present embodiment.

The control signals ϕRESL2, φRESL1, φRESL0, and φRESn are supplied to the buffer circuit 30, and the control signal φRES_O is generated by the control signals. The control signals φSEL_O, φTX_O, and φRES_O indicate control signals supplied to the unit pixels 11 to be read out in the pixel unit 10. The voltage of the column signal line 13 illustrates an example in a state in which high illuminance light is incident on the unit pixel 11 and charges overflow from the photoelectric conversion element PD to the input node FD. The broken line indicates the FD clip level by the gate voltage of the reset transistor M2, and the one-dot chain line schematically indicates the VL clip level by the column signal line clip circuit 40. “N conversion” schematically indicates the timing of AD conversion of the reset signal, and “S conversion” schematically indicates the timing of AD conversion of the pixel signal.

Immediately before time t1 illustrated in FIG. 4, since the control signal φRESn is at low level, the control signal φRES_O output from the buffer circuit 30 is at high level (voltage VRESH). Since the voltage VRESH is supplied to the gate of the reset transistor M2, the reset transistor M2 is turned on, and the input node FD is reset to a voltage (reset voltage) of a reset level corresponding to the voltage VDD.

At time t1 illustrated in FIG. 4, the vertical scanning circuit 20 controls the control signal φSEL_O from low level to high level for the target unit pixel 11 (the unit pixels 11 of two rows) in the pixel unit 10. The selection transistor M4 of the target unit pixel 11 is turned on, and the amplification transistor M3 of the target unit pixel 11 is connected to the column signal line 13 via the selection transistor M4. As a result, a bias current is supplied from the current source 50 to the amplification transistor M3 via the column signal line 13 and the selection transistor M4, and a reset signal corresponding to the reset voltage of the input node FD is output to the column signal line 13 via the selection transistor M4. The readout of the reset signal is started for the unit pixels 11 of the two rows simultaneously read out.

At time t2, the vertical scanning circuit 20 controls the control signal φRESn from low level to high level. The N-type MOS transistor M6 of the buffer circuit 30 is turned on, and the control signal φRES_O output from the buffer circuit 30 becomes low level. At this time, since the control signals φRESL1 and φRESL2 are at low level and the control signal φRESL0 is at high level, the transistors M8 and M9 of the buffer circuit 30 are turned off and the transistor M7 is turned on. The voltage VRESL0 (for example, 0 V) is supplied to the gate of the reset transistor M2 as the control signal φRES_O via the transistor M7. The reset transistor M2 of the unit pixel 11 is turned off, and the input node FD is disconnected from the power supply (voltage VDD) and enters a floating state.

Here, high illuminance light is incident on the unit pixel 11, and the charge that can be accumulated in the photoelectric conversion element PD is saturated, the charge overflows from the photoelectric conversion element PD to the input node FD. Since the charge overflows to the input node FD in this manner, the voltage of the column signal line 13 decreases. During the readout period of the reset signal (time t2 to time t6), since the VL clip level is higher than the FD clip level, the voltage of the column signal line 13 stops decreasing at the VL clip level.

From time t3 to time t4 (first period), the AD conversion circuit 61 performs AD conversion of the reset signal at the time of resetting the input node FD, and outputs the reset signal after the AD conversion to the memory 62 (in the figure, “N conversion”) The memory 62 stores the reset signal after the AD conversion output from the AD conversion circuit 61.

At time t5, the vertical scanning circuit 20 controls the control signal φRESL0 from high level to low level, and controls the control signal φRESL1 from low level to high level. The transistor M7 of the buffer circuit 30 is turned off and the transistor M8 is turned on. The voltage VRESL1 (for example, 0.6 V) is supplied as the control signal φRES_O to the gate of the reset transistor M2 of the unit pixel 11 via the transistor M8. The reset transistor M2 functions as a clip transistor that limits the amplitude of the pixel signal at the FD clip level according to the gate voltage (for example, 0.6 V). The FD clip level is determined by the gate voltage of the reset transistor M2. Therefore, as the voltage of the control signal φRES_O rises from the voltage VRESL0 (for example, 0 V) to the voltage VRESL1 (for example, 0.6 V), the FD clip level also rises.

At time t6, the column signal line clip circuit 40 lowers the VL clip level than the FD clip level. At the same time t6, the vertical scanning circuit 20 controls the control signal φTX_O from low level to high level. The transfer transistor M1 of the unit pixel 11 is turned on, and the charge accumulated in the photoelectric conversion element PD is transferred to the input node FD. The transferred charge is further added to the charge already overflowing from the photoelectric conversion element PD to the input node FD, and the voltage of the input node FD further decreases. When the voltage of the input node FD decreases, the reset transistor M2 is temporarily turned on, and the voltage of the input node FD is limited to the FD clip level based on the voltage VRESL1. Further, since the VL clip level is controlled to be lower than the FD clip level, the voltage of the column signal line 13 is also limited to the FD clip level.

At time t7, the vertical scanning circuit 20 controls the control signal φTX_O from high level to low level. The transfer transistor M1 of the unit pixel 11 is turned off, and the transfer of the charge from the photoelectric conversion element PD to the input node FD is stopped.

At time t8, the vertical scanning circuit 20 controls the control signal φRESL1 from high level to low level, and controls the control signal φRESL0 from low level to high level. The transistor M8 of the buffer circuit 30 is turned off and the transistor M7 is turned on. The voltage VRESL0 (for example, 0 V) is supplied as the control signal φRES_O to the gate of the reset transistor M2 of the unit pixel 11 via the transistor M7. The reset transistor M2 functions as a clip transistor that limits the amplitude of the pixel signal at the FD clip level according to the gate voltage (for example, 0 V). The FD clip level is determined by the gate voltage of the reset transistor M2. Therefore, when the voltage of the control signal φRES_O decreases from the voltage VRESL1 (for example, 0.6 V) to the voltage VRESL0 (for example, 0 V), the FD clip level also decreases. At this time, since the charge of the input node FD has already been discharged to the power supply (voltage VDD), the voltage of the column signal line 13 does not change significantly.

At time t9, the photoelectric conversion element PD becomes saturated, and the charge starts to overflow from the photoelectric conversion element PD to the input node FD again. The voltages of the input node FD and the column signal line 13 start to decrease, and the decrease of the voltages of the input node FD and the column signal line 13 is stopped at the FD clip level based on the voltage VRESL0. An amount of the voltage drop of the column signal line 13 is determined by the voltage difference between the voltage VRES1 and the voltage VRESL0. When the illuminance is not high such that the charge overflows to the input node FD again immediately after the transfer of the charge, the amplitude of the column signal line 13 is limited at the FD clip level based on the voltage VRESL1.

In the period from time t10 to time t11 (second period), the AD conversion circuit 61 performs AD conversion of the pixel signal based on the charge corresponding to the incident light, and outputs the pixel signal after the AD conversion to the memory 62 (in the figure, “S conversion”). The memory 62 stores the pixel signal after the AD conversion output from the AD conversion circuit 61. The horizontal scanning circuit 70 sequentially scans the memories 62, and outputs the reset signal and the pixel signal after the AD conversion held in each of the memories 62 to the signal processing circuit 80. The signal processing circuit 80 subtracts the reset signal from the pixel signal, extracts only a signal corresponding to the amount of incident light, and outputs the extracted signal to the outside of the photoelectric conversion device.

At time t12, the vertical scanning circuit 20 controls the control signal φRESn from high level to low level. The P-type MOS transistor M5 of the buffer circuit 30 is turned on, and the control signal φRES_O output from the buffer circuit 30 becomes high level (voltage VRESH). The voltage VRESH is supplied to the gate of the reset transistor M2, the reset transistor M2 is turned on, and the input node FD is reset to a voltage (reset voltage) of a reset level corresponding to the voltage VDD.

At time t13, the vertical scanning circuit 20 controls the control signal φSEL_O from high level to low level. The selection transistor M4 of the unit pixel 11 is turned off, the amplification transistor M3 of the unit pixel 11 is disconnected from the column signal line 13, and the reading of the signals of the unit pixels 11 of the two rows to be simultaneously read ends. As described above, in the high illuminance drive mode, the control signal φRES_O is switched to low level between the voltage VRESL0 and the voltage VRESL1 to control the FD clip level.

Next, the low illuminance driving mode will be described. The low illuminance driving mode is different from the high illuminance driving mode illustrated in FIG. 4 in that the FD clip level is increased, and the same processing is executed in other modes. FIG. 5 is a timing chart illustrating an operation example of the photoelectric conversion device in a low illuminance driving mode according to the present embodiment.

In the figure, control signals φSEL_O, φTX_O, and φRES_O are supplied to the unit pixels 11 to be read out in the pixel unit 10. In the figure, control signals φRESL2, φRESL1, φRESL0, and φRESn are supplied to the buffer circuit 30, and a control signal φRES_O is generated by the control signals. In the figure, an example of the voltage of the column signal line 13 in a state in which high illuminance light is incident on the unit pixel 11 and charges overflow from the photoelectric conversion element PD to the input node FD is illustrated. Further, in the figure, the FD clip level by the gate voltage of the reset transistor M2 is schematically illustrated by a broken line, and the VL clip level by the column signal line clip circuit 40 is schematically illustrated by a one-dot chain line. In the figure, the timing of AD conversion of the reset signal is schematically indicated by “N conversion”, and the timing of AD conversion of the pixel signal is schematically indicated by “S conversion”.

Immediately before time t1a illustrated in FIG. 5, since the control signal φRESn is at low level, the control signal φRES_O output from the buffer circuit 30 is at high level (voltage VRESH). The voltage VRESH is supplied to the gate of the reset transistor M2, the reset transistor M2 is turned on, and the input node FD is reset to a voltage (reset voltage) of a reset level corresponding to the voltage VDD.

At time t1a illustrated in FIG. 4, the vertical scanning circuit 20 controls the control signal φSEL_O from low level to high level for the target unit pixel 11 (the unit pixels 11 of two rows) in the pixel unit 10. The selection transistor M4 of the target unit pixel 11 is turned on, and the amplification transistor M3 of the target unit pixel 11 is connected to the column signal line 13 via the selection transistor M4. As a result, a bias current is supplied from the current source 50 to the amplification transistor M3 via the column signal line 13 and the selection transistor M4, and a reset signal corresponding to the reset voltage of the input node FD is output to the column signal line 13 via the selection transistor M4. The readout of the reset signal is started for the unit pixels 11 of the two rows simultaneously read out.

At time t2a, the vertical scanning circuit 20 controls the control signal φRESn from low level to high level. The N-type MOS transistor M6 of the buffer circuit 30 is turned on, and the control signal φRES_O output from the buffer circuit 30 becomes low level. At this time, since the control signals φRESL0 and φRESL2 are at low level and the control signal φRESL1 is at high level, the transistors M7 and M9 of the buffer circuit 30 are turned off and the transistor M8 is turned on. The voltage VRESL1 (for example, 0.6 V) is supplied to the gate of the reset transistor M2 as the control signal φRES_O via the transistor M8. The reset transistor M2 of the unit pixel 11 is turned off, and the input node FD is disconnected from the power supply (voltage VDD) and enters a floating state.

Here, a state is illustrated in which high illuminance light is incident on the unit pixel 11, the charge that can be accumulated in the photoelectric conversion element PD is saturated, and the charge overflows from the photoelectric conversion element PD to the input node FD. Since the charge overflows to the input node FD in this manner, the voltage of the column signal line 13 decreases. During the readout period of the reset signal (time t2a to time t6a), since the VL clip level is higher than the FD clip level, the voltage of the column signal line 13 stops decreasing at the VL clip level.

From time t3a to time t4a (first period), the AD conversion circuit 61 performs AD conversion of the reset signal and outputs the reset signal after the AD conversion to the memory 62 (in the figure, “N conversion”). The memory 62 stores the reset signal after the AD conversion output from the AD conversion circuit 61.

At time t5a, the vertical scanning circuit 20 controls the control signal φRESL1 from high level to low level, and controls the control signal φRESL2 from low level to high level. The transistor M8 of the buffer circuit 30 is turned off and the transistor M9 is turned on. The voltage VRESL2 (for example, 1.2 V) is supplied as the control signal φRES_O to the gate of the reset transistor M2 of the unit pixel 11 via the transistor M9. The reset transistor M2 functions as a clip transistor that limits the amplitude of the pixel signal at the FD clip level according to the gate voltage (for example, 1.2 V). Since the FD clip level is determined by the gate voltage of the reset transistor M2, the FD clip level also rises as the voltage of the control signal φRES_O rises from the voltage VRESL1 (for example, 0.6 V) to the voltage VRESL2 (for example, 1.2 V).

At time t6a, the column signal line clip circuit 40 lowers the VL clip level than the FD clip level. At the same time t6a, the vertical scanning circuit 20 controls the control signal φTX_O from low level to high level. The transfer transistor M1 of the unit pixel 11 is turned on, and the charge accumulated in the photoelectric conversion element PD is transferred to the input node FD. The transferred charge is further added to the charge already overflowing from the photoelectric conversion element PD to the input node FD, and the voltage of the input node FD further decreases. When the voltage of the input node FD decreases, the reset transistor M2 is temporarily turned on, and the voltage of the input node FD is limited to the FD clip level based on the voltage VRESL2. Further, since the VL clip level is controlled to be lower than the FD clip level, the voltage of the column signal line 13 is also limited to the FD clip level.

At time t7a, the vertical scanning circuit 20 controls the control signal φTX_O from high level to low level. The transfer transistor M1 of the unit pixel 11 is turned off, and the transfer of the charge from the photoelectric conversion element PD to the input node FD is stopped.

At time t8a, the vertical scanning circuit 20 controls the control signal φRESL2 from high level to low level, and controls the control signal φRESL1 from low level to high level. The transistor M9 of the buffer circuit 30 is turned off and the transistor M8 is turned on. The voltage VRESL1 (for example, 0.6 V) is supplied as the control signal φRES_O to the gate of the reset transistor M2 of the unit pixel 11 via the transistor M8. The reset transistor M2 functions as a clip transistor that limits the amplitude of the pixel signal at the FD clip level according to the gate voltage (for example, 0.6 V). Since the FD clip level is determined by the gate voltage of the reset transistor M2, the FD clip level also decreases as the voltage of the control signal φRES_O decreases from the voltage VRESL2 (for example, 1.2 V) to the voltage VRESL1 (for example, 0.6 V). At this time, since the charge of the input node FD has already been discharged to the power supply (voltage VDD), the voltage of the column signal line 13 does not change significantly.

At time t9a, the photoelectric conversion element PD becomes saturated, and the charge starts to overflow from the photoelectric conversion element PD to the input node FD again. The voltages of the input node FD and the column signal line 13 start to decrease, and the decrease of the voltages of the input node FD and the column signal line 13 is stopped at the FD clip level based on the voltage VRESL1. An amount of the voltage drop of the column signal line 13 is determined by the voltage difference between the voltage VRES2 and the voltage VRESL1. When the illuminance is not high such that the charge overflows to the input node FD again immediately after the transfer of the charge, the amplitude of the column signal line 13 is limited at the FD clip level based on the voltage VRESL2.

From time t10a to time t11a (second period), the AD conversion circuit 61 performs AD conversion of the pixel signal and outputs the pixel signal after the AD conversion to the memory 62 (in the figure, “S conversion”). The memory 62 stores the pixel signal after the AD conversion output from the AD conversion circuit 61. The horizontal scanning circuit 70 sequentially scans the memories 62, and outputs the reset signal and the pixel signal after the AD conversion held in each of the memories 62 to the signal processing circuit 80. The signal processing circuit 80 subtracts the reset signal from the pixel signal, extracts only a signal corresponding to the amount of incident light, and outputs the extracted signal to the outside of the photoelectric conversion device.

At time t12a, the vertical scanning circuit 20 controls the control signal φRESn from high level to low level. The P-type MOS transistor M5 of the buffer circuit 30 is turned on, and the control signal φRES_O output from the buffer circuit 30 becomes high level (voltage VRESH). The voltage VRESH is supplied to the gate of the reset transistor M2, the reset transistor M2 is turned on, and the input node FD is reset to a voltage (reset voltage) of a reset level corresponding to the voltage VDD.

At time t13a, the vertical scanning circuit 20 controls the control signal φSEL_O from high level to low level. The selection transistor M4 of the unit pixel 11 is turned off, the amplification transistor M3 of the unit pixel 11 is disconnected from the column signal line 13, and the reading of the signals of the unit pixels 11 of the two rows to be simultaneously read ends. As described above, in the low illuminance drive mode, the control signal φRES_O is switched to low level between the voltage VRESL1 and the voltage VRESL2 to control the FD clip level.

As described above, according to the photoelectric conversion device and the control method thereof according to the present embodiment, the reset transistor M2 that operates as a clip transistor can switch between the low illuminance driving mode and the high illuminance driving mode. In the high illuminance driving mode, the voltage VRESL0 is supplied to the gate of the reset transistor M2 in a period in which the reset signal and the pixel signal are converted from analog to digital. In addition, in a charge transfer period in which the transfer transistor M1 is turned on after the period in which the reset signal is converted from analog to digital and before the period in which the pixel signal is converted from analog to digital, the voltage VRESL1 higher than the voltage VRESL0 is supplied to the gate of the reset transistor M2. In the low illuminance driving mode, a voltage VRESL1 higher than the voltage VRESL0 is supplied to the gate of the reset transistor M2 in a period in which the reset signal and the pixel signal are converted from analog to digital. In a charge transfer period in which the transfer transistor M1 is on, a voltage VRESL2 higher than the voltage VRESL1 is supplied to the gate of the reset transistor M2.

As described above, in the high illuminance drive mode, low level of the control signal φRES_O is switched between the voltage VRESL0 and the voltage VRESL1, and in the low illuminance drive mode, low level of the control signal φRES_O is switched between the voltage VRESL1 and the voltage VRESL2. In the low illuminance driving mode, the voltage VRESL2 is supplied to the gate of the reset transistor M2 during the charge transfer period, and the amplitude of the column signal line 13 is limited at the FD clip level based on the voltage VRESL2 in the illuminance range in which charge overflow does not occur after the charge transfer. Therefore, it is possible to reduce the fluctuation of the power supply voltage due to the amplitude of the column signal line 13 accompanying the charge transfer and to suppress the influence on the image quality.

Even in an imaging situation in which the low illuminance driving mode is set, very high illuminance light such as the sun may be incident on some of the unit pixels 11. Therefore, even in the low illuminance driving mode, it is necessary to suppress the influence of the image quality at the time of the high illuminance in which the charge overflow occurs after the charge transfer. According to the low illuminance driving mode, at a high illuminance at which charge overflow occurs after charge transfer, the amount of the voltage drop of the column signal line 13 accompanying a drop in the FD clip level is determined by the voltage difference between the voltage VRESL1 and the voltage VRESL2. The difference between the voltage VRESL1 and the voltage VRESL2 in the low illuminance driving mode corresponds to the difference between the voltage VRESL0 and the voltage VRESL1 in the high illuminance driving mode. Here, the difference between the voltage VRESL1 and the voltage VRESL2 coincides with the difference between the voltage VRESL0 and the voltage VRESL1. In this way, low level of the control signal φRES_O is raised to the voltage VRESL1 in a period other than the charge transfer period in the low illuminance drive mode. Therefore, the amount of the voltage drop of the column signal line 13 can be reduced as compared with the case where low level of the control signal φRES_O is raised only in the charge transfer period. In the low illumination driving mode, it is possible to suppress the deterioration of peripheral image quality caused by the fluctuation in the power supply, which occurs when the column signal line 13 varies due to the charge overflow after the charge transfer. Additionally, a crosstalk caused by parasitic capacitance between the column signal lines 13 can be suppressed.

Further, according to the photoelectric conversion device of the present embodiment, low level of the control signal φRES_O in the charge transfer period in the high illuminance drive mode and low level of the control signal φRES_O in the AD conversion period in the low illuminance drive mode are the same voltage VRESL1. As a result, the number of transistors at the time of outputting low level of the control signal φRES_O can be reduced, so that the size of the device can be reduced.

Further, according to the photoelectric conversion device of the present embodiment, in the high illuminance driving mode, the period in which the voltage VRESL1 is supplied to the gate of the reset transistor M2 operating as the clip transistor is longer than the period in which the transfer transistor M1 is on. Specifically, after the voltage VRESL1 is supplied to the gate of the reset transistor M2, the transfer transistor M1 is turned on, and after the transfer transistor M1 is turned off, the voltage VRESL0 is supplied to the gate of the reset transistor M2. A period from when the transfer transistor M1 is turned off to when the voltage VRESL0 is supplied to the gate of the reset transistor M2 is longer than a period from when the voltage VRESL1 is supplied to the gate of the reset transistor M2 to when the transfer transistor M1 is turned on. Accordingly, it is possible to sufficiently secure a time during which the charge of the input node FD is discharged to the power supply (voltage VDD) at the time of charge transfer.

Further, according to the photoelectric conversion device of the present embodiment, in the low illuminance driving mode, the period in which the voltage VRESL2 is supplied to the gate of the reset transistor M2 operating as the clip transistor is longer than the period in which the transfer transistor M1 is on. Specifically, after the voltage VRESL2 is supplied to the gate of the reset transistor M2, the transfer transistor M1 is turned on, and after the transfer transistor M1 is turned off, the voltage VRESL1 is supplied to the gate of the reset transistor M2. A period from when the transfer transistor M1 is turned off to when the voltage VRESL1 is supplied to the gate of the reset transistor M2 is longer than a period from when the voltage VRESL2 is supplied to the gate of the reset transistor M2 to when the transfer transistor M1 is turned on. Accordingly, it is possible to sufficiently secure a time during which the charge of the input node FD is discharged to the power supply (voltage VDD) at the time of charge transfer.

In addition, according to the photoelectric conversion device according to the present embodiment, the AD conversion circuit 61 simultaneously performs AD conversion of the pixel signals output from the unit pixels 11 in the rows. Thus, the processing speed of the photoelectric conversion device can be improved.

Further, according to the photoelectric conversion device of the present embodiment, the FD clip level is lower than the VL clip level in the AD conversion period of the reset signal, and the FD clip level is higher than the VL clip level in the charge transfer period and the AD conversion period of the pixel signal. Accordingly, the amplitude of the reset signal can be limited at the VL clip level, and the amplitude of the pixel signal can be limited at the FD clip level.

### Second Embodiment

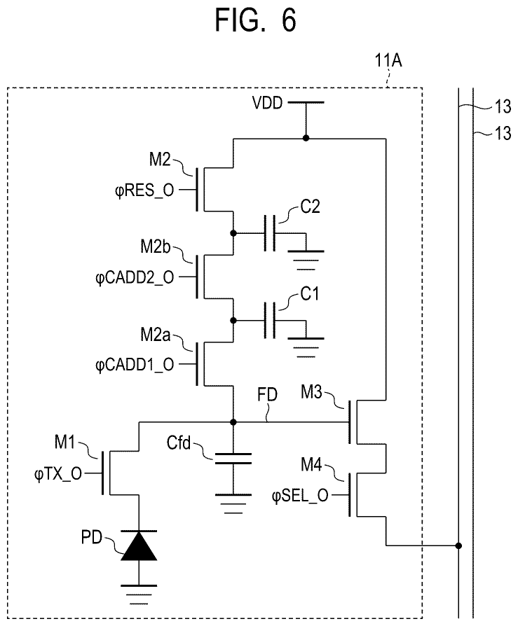

A photoelectric conversion device and a driving method thereof according to a second embodiment will be described with reference to FIGS. 6 to 13. First, a configuration example of a unit pixel of the photoelectric conversion device according to the present embodiment will be described with reference to FIG. 6. FIG. 6 is a circuit diagram illustrating a configuration example of a unit pixel according to the embodiment. The photoelectric conversion device according to the present embodiment differs from the photoelectric conversion device according to the first embodiment in that the capacitance of the input node FD can be changed. In the present embodiment, the same components as those in the first embodiment are denoted by the same reference numerals, and a detailed description thereof will be appropriately omitted.

The unit pixel 11A converts incident light into an electrical signal and outputs the electrical signal. As illustrated in FIG. 6, the unit pixel 11A includes a photoelectric conversion element PD, a transfer transistor M1, a reset transistor M2, an amplification transistor M3, a selection transistor M4, a first capacitance addition transistor M2a, and a second capacitance addition transistor M2b.

An anode of the photoelectric conversion element PD is connected to a ground node, and a cathode of the photoelectric conversion element PD is connected to a source of the transfer transistor M1. A drain of the transfer transistor M1 is connected to a source (first main node) of the first capacitance addition transistor M2a and a gate of the amplification transistor M3. An input node FD to which the drain of the transfer transistor M1, the source of the first capacitance addition transistor M2a, and the gate of the amplification transistor M3 are connected is a so-called floating diffusion portion (floating diffusion portion).

A drain (second main node) of the first capacitance addition transistor M2a is connected to a source (first main node) of the second capacitance addition transistor M2b, and a drain (second main node) of the second capacitance addition transistor M2b is connected to a source of the reset transistor M2. That is, the first capacitance addition transistor M2a and the second capacitance addition transistor M2b are provided between the input node FD and the reset transistor M2. The first capacitance addition transistor M2a and the second capacitance addition transistor M2b can add capacitance to the input node FD, and function as switches that change the capacitance of the input node FD.

A drain of the reset transistor M2 and a drain of the amplification transistor M3 are connected to a power supply voltage node to which the voltage VDD is supplied. A source of the amplification transistor M3 is connected to a drain of the selection transistor M4. A source of the selection transistor M4 is connected to the column signal line 13.

The control signal φCADD1_O is supplied from the vertical scanning circuit 20 to the gate of the first capacitance addition transistor M2a via the buffer circuit 30A. When the control signal φCADD1_O is at high level, the first capacitance addition transistor M2a is turned on, and when the control signal φCADD1_O is at low level, the first capacitance addition transistor M2a is turned off. Here, the control signal φCADD1_O can cause the first capacitance addition transistor M2a to function as a clip transistor that limits the amplitude of the pixel signal at the FD clip level (clip level) corresponding to the gate voltage of the first capacitance addition transistor M2a.

The control signal φCADD2_O is supplied from the vertical scanning circuit 20 to the gate of the second capacitance addition transistor M2b via the buffer circuit 30A. When the control signal φCADD2_O is at high level, the second capacitance addition transistor M2b is turned on, and when the control signal φCADD2 is at low level, the second capacitance addition transistor M2b is turned off. Here, the control signal φCADD2_O can cause the second capacitance addition transistor M2b to function as a clip transistor that limits the amplitude of the pixel signal at the FD clip level (clip level) corresponding to the gate voltage of the second capacitance addition transistor M2b.

By turning on all of the reset transistor M2, the first capacitance addition transistor M2a, and the second capacitance addition transistor M2b, the input node FD is reset to a voltage corresponding to the voltage VDD.

On the other hand, by controlling on/off of the first capacitance addition transistor M2a and the second capacitance addition transistor M2b, the coefficient of charge-voltage conversion by the floating diffusion portion can be changed. Specifically, when the first capacitance addition transistor M2a is turned off, the capacitance of the input node FD becomes Cfd. When the first capacitance addition transistor M2a is turned on and the second capacitance addition transistor M2b is turned off, the capacitance of the input node FD increases to Cfd+C1. When the first capacitance addition transistor M2a and the second capacitance addition transistor M2b are turned on and the reset transistor is turned off, the capacitance of the input node FD further increases to Cfd+C1+C2. As described above, by turning on the first capacitance addition transistor M2a and the second capacitance addition transistor M2b, it is possible to increase the capacitance connected to the input node FD and change the coefficient of charge-voltage conversion by the floating diffusion portion. That is, the unit pixel 11A is configured to change the coefficient of charge-voltage conversion by changing the capacitance of the input node FD in three stages of “large”, “medium”, and “small”. When the capacitance of the input node FD is “large”, the gain in the charge-voltage conversion becomes “low gain”. When the capacitance of the input node FD is “medium”, the gain in the charge-voltage conversion is “medium gain”. When the capacitance of the input node FD is “small”, the gain in the charge-voltage conversion becomes “high gain”.

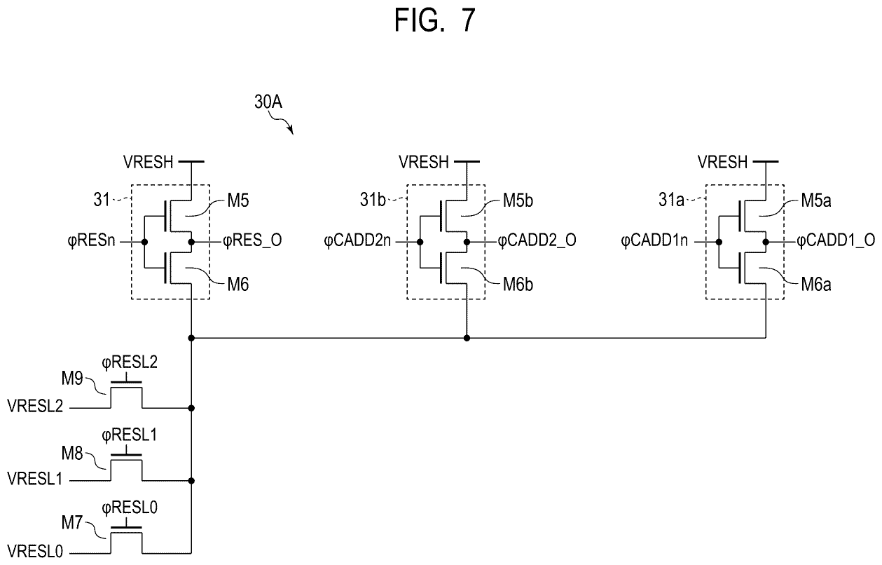

Next, the configuration of the buffer circuit 30A will be described with reference to FIG. 7. FIG. 7 is a circuit diagram illustrating a configuration example of the buffer circuit 30A according to the present embodiment. The buffer circuit 30A not only functions as a circuit for amplifying the control signal output from the vertical scanning circuit 20, but also converts the signal between high level and low level. As illustrated in FIG. 7, the buffer circuit 30A includes inverters 31, 31a, and 31b, and transistors M7, M8, and M9.

The inverter 31a includes a P-type MOS transistor M5a and an N-type MOS transistor M6a.

The gate of the P-type MOS transistor M5a is connected to the vertical scanning circuit 20, and a control signal φCADD1n is output from the vertical scanning circuit 20. The P-type MOS transistor M5a has a source connected to the power supply (voltage VRESH) and a drain connected to a drain of the N-type MOS transistor M6a and the gate of the first capacitance addition transistor M2a.

A gate of the N-type MOS transistor M6a is connected to the vertical scanning circuit 20, and receives the control signal φCADD1n from the vertical scanning circuit 20. The drain of the N-type MOS transistor M6a is connected to a drain of the P-type MOS transistor M5a and the gate of the first capacitance addition transistor M2a, and a source thereof is connected to sources of the transistors M7, M8, and M9.

The inverter 31b includes a P-type MOS transistor M5b and an N-type MOS transistor M6b.

A gate of the P-type MOS transistor M5b is connected to the vertical scanning circuit 20, and receives a control signal φCADD2n from the vertical scanning circuit 20. The P-type MOS transistor M5b has a source connected to the power supply (voltage VRESH) and a drain connected to a drain of the N-type MOS transistor M6b and the gate of the second capacitance addition transistor M2b.

A gate of the N-type MOS transistor M6b is connected to the vertical scanning circuit 20, and receives the control signal φCADD2n from the vertical scanning circuit 20. The drain of the N-type MOS transistor M6b is connected to a drain of the P-type MOS transistor M5b and the gate of the second capacitance addition transistor M2b, and a source thereof is connected to the sources of the transistors M7, M8, and M9.

A gate of the transistor M7 is connected to the vertical scanning circuit 20, and receives a control signal φRESL0 from the vertical scanning circuit 20. A drain of the transistor M7 is connected to the power supply (voltage VRESL0), and a source thereof is connected to the sources of the N-type MOS transistors M6, M6a, and M6b. The transistor M7 is turned on when the high-level control signal φRESL0 is output, and supplies a voltage VRESL0 (for example, 0 V) to the inverters 31, 31a, and 31b. The transistor M7 is turned off when the low-level control signal φRESL0 is output, and does not supply the voltage VRESL0 (for example, 0 V) to the inverters 31, 31a, and 31b.

A gate of the transistor M8 is connected to the vertical scanning circuit 20, and receives a control signal φRESL1 from the vertical scanning circuit 20. The drain of the transistor M8 is connected to the power supply (voltage VRESL1), and the source thereof is connected to the sources of the N-type MOS transistors M6, M6a, and M6b. The transistor M8 is turned on when the high-level control signal φRESL1 is output, and supplies a voltage VRESL1 (for example, 0.6 V) to the inverters 31, 31a, and 31b. The transistor M8 is turned off when the low-level control signal φRESL1 is output, and does not supply the voltage VRESL1 (for example, 0.6 V) to the inverters 31, 31a, and 31b. A gate of the transistor M9 is connected to the vertical scanning circuit 20, and receives a control signal φRESL2 from the vertical scanning circuit 20. A drain of the transistor M9 is connected to the power supply (voltage VRESL2), and a source thereof is connected to the sources of the N-type MOS transistors M6, M6a, and M6b. The transistor M9 is turned on when the high-level control signal φRESL2 is output, and supplies a voltage VRESL2 (for example, 1.2 V) to the inverters 31, 31a, and 31b. The transistor M9 is turned off when the low-level control signal φRESL2 is output, and does not supply the voltage VRESL2 (for example, 1.2 V) to the inverters 31, 31a, and 31b.

As described above, the buffer circuit 30A is configured to be capable of switching low levels of the inverters 31, 31a, and 31b in three stages (0 V, 0.6 V, and 1.2 V) by switching the control signals φRESL0, φRESL1, and φRESL2. In the inverter 31a, when the control signal φCADD1n output from the vertical scanning circuit 20 is at low level, the P-type MOS transistor M5a is turned on. Then, high level (voltage VRESH) is supplied to the gate of the first capacitance addition transistor M2a as the control signal φCADD1_O. On the other hand, when the control signal φCADD1n output from the vertical scanning circuit 20 is at high level, the N-type MOS transistor M6a is turned on. Then, low level (Voltage of any one of the voltage VRESL0, the voltage VRESL1, and the voltage VRESL2) is supplied to the gate of the first capacitance addition transistor M2a as the control signal φCADD1_O. In this way, the buffer circuit 30A performs logic inversion and amplification of the control signal φCADD1n by the inverter 31a, and supplies the control signal φCADD1_O to the gate of the first capacitance addition transistor M2a of each unit pixel 11.

In the inverter 31b, when the control signal φCADD2n output from the vertical scanning circuit 20 is at low level, the P-type MOS transistor M5b is turned on. Then, high level (voltage VRESH) is supplied to the gate of the second capacitance addition transistor M2b as the control signal φCADD2_O. On the other hand, when the control signal φCADD2n output from the vertical scanning circuit 20 is at high level, the N-type MOS transistor M6b is turned on. Then, low level (Voltage of any one of the voltage VRESL0, the voltage VRESL1, and the voltage VRESL2) is supplied to the gate of the second capacitance addition transistor M2b as the control signal φCADD2_O. In this way, the buffer circuit 30A performs logic inversion and amplification of the control signal φCADD2n by the inverter 31b, and supplies the control signal φCADD2_O to the gate of the second capacitance addition transistor M2b of each unit pixel 11.

As described above, the sources of the N-type MOS transistors M6, M6a, and M6b of the inverters 31, 31a, and 31b are connected to the same low-level power supply. Low levels of the control signals φRES_O, φCADD1_O, and φCADD2_O can be switched in three stages of the voltages VRESL0, VRESL1, and VRESL2.

Next, the high illuminance driving mode and the low illuminance driving mode will be described for each three-stage gain. The photoelectric conversion device has six drive modes, i.e., a low-gain high illuminance drive mode, a low-gain low illuminance drive mode, a medium-gain high illuminance drive mode, a medium-gain low illuminance drive mode, a high-gain high illuminance drive mode, and a high-gain low illuminance drive mode, according to the amount of incident light. The six drive modes may be selected during imaging.

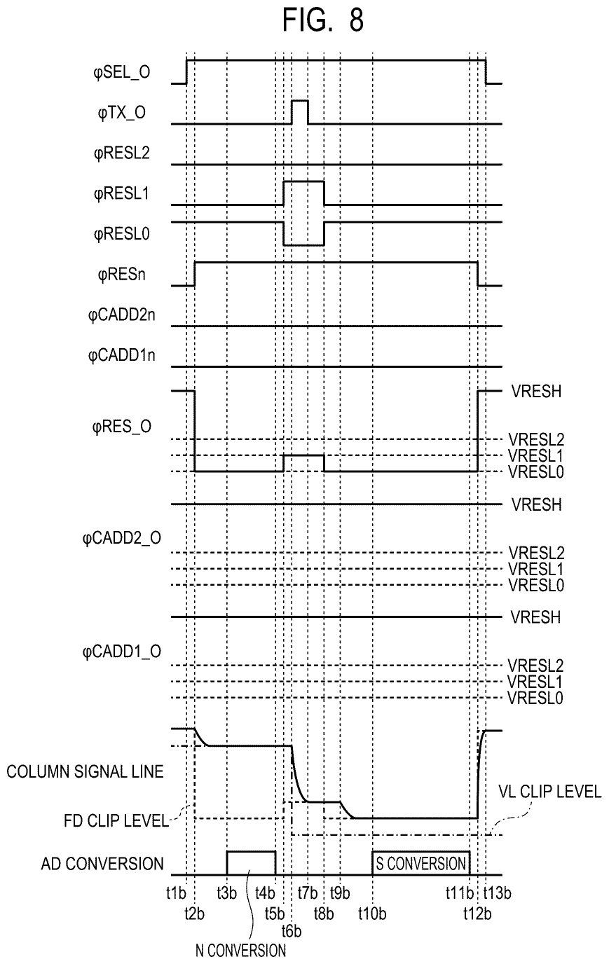

FIG. 8 is a timing chart illustrating an operation example of the photoelectric conversion device in the low-gain high illuminance driving mode according to the present embodiment.

In the figure, control signals φRESL2, φRESL1, φRESL0, and φRESn are supplied to the buffer circuit 30A, and a control signal φRES_O is generated by this control signal. In the figure, control signals φSEL_O, φTX_O, and φRES_O are supplied to the unit pixels 11 to be read out in the pixel unit 10. In the figure, the control signal φCADD1n and the control signal φCADD2n are supplied to the buffer circuit 30A, and the control signal φCADD1_O and the control signal φCADD2_O are generated by this control signal. In the figure, a control signal φCADD1_O and a control signal φCADD2_O indicate control signals that are supplied to the unit pixel 11 to be read out in the pixel unit 10 and supplied to the gates of the first and second capacitance addition transistors M2a and M2b. In the figure, an example of the voltage of the column signal line 13 in a state in which high illuminance light is incident on the unit pixel 11 and charges overflow from the photoelectric conversion element PD to the input node FD is illustrated. Further, in the figure, the FD clip level by the gate voltage of each transistor is schematically illustrated by a broken line, and the VL clip level by the column signal line clip circuit 40 is schematically illustrated by a one-dot chain line. In the figure, the timing of AD conversion of the reset signal is schematically indicated by “N conversion”, and the timing of AD conversion of the pixel signal is schematically indicated by “S conversion”.

In the case of the low-gain high illuminance driving mode, immediately before time t1b illustrated in FIG. 8, the control signals φCADD1n and φCADD2n are at low level. Therefore, the control signal φCADD1_O and the control signal φCADD2_O output from the buffer circuit 30A become high level (voltage VRESH), and the voltage VRESH is supplied to the gates of the first and second capacitance addition transistors M2a and M2b. The first and second capacitance addition transistors M2a and M2b are turned on, and the capacitance of the input node FD becomes Cfd+C1+C2 (capacitance “large”). The gain in the charge-voltage conversion becomes “low gain”. Therefore, the amplitude of the signal at the input node FD becomes small, and the pixel signal can be converted from analog to digital without being clipped even for a subject with higher illuminance. Immediately before time t1b, since the control signal φRESn is at low level, the control signal φRES_O output from the buffer circuit 30A is at high level (voltage VRESH). Since the voltage VRESH is supplied to the gate of the reset transistor M2, the reset transistor M2 is turned on, and the input node FD is reset to a voltage (reset voltage) of a reset level corresponding to the voltage VDD.

At time t1b illustrated in FIG. 8, the vertical scanning circuit 20 controls the control signal φSEL_O from low level to high level for the target unit pixel 11 (the unit pixels 11 of two rows) in the pixel unit 10. The selection transistor M4 of the target unit pixel 11 is turned on, and the amplification transistor M3 of the target unit pixel 11 is connected to the column signal line 13 via the selection transistor M4. As a result, a bias current is supplied from the current source 50 to the amplification transistor M3 via the column signal line 13 and the selection transistor M4, and a reset signal corresponding to the reset voltage of the input node FD is output to the column signal line 13 via the selection transistor M4. The readout of the reset signal is started for the unit pixels 11 of the two rows simultaneously read out.

At time t2b, the vertical scanning circuit 20 controls the control signal φRESn from low level to high level. The N-type MOS transistor M6 of the buffer circuit 30A is turned on, and the control signal φRES_O output from the buffer circuit 30A becomes low level. At this time, since the control signals φRESL1 and φRESL2 are at low level and the control signal φRESL0 is at high level, the transistors M8 and M9 of the buffer circuit 30A are turned off and the transistor M7 is turned on. The gate of the reset transistor M2 is supplied with a voltage VRESL0 (for example, 0 V) as a control signal φRES_O via the transistor M7. The reset transistor M2 of the unit pixel 11 is turned off, and the input node FD is disconnected from the power supply (voltage VDD) and enters a floating state.

Here, a state is illustrated in which high illuminance light is incident on the unit pixel 11, the charge that can be accumulated in the photoelectric conversion element PD is saturated, and the charge overflows from the photoelectric conversion element PD to the input node FD. Since the charge overflows to the input node FD in this manner, the voltage of the column signal line 13 decreases. During the readout period of the reset signal (time t2b to time t6b), the VL clip level becomes higher than the FD clip level, and the voltage of the column signal line 13 stops decreasing at the VL clip level.

From time t3b to time t4b, the AD conversion circuit 61 performs AD conversion of the reset signal, and outputs the reset signal after the AD conversion to the memory 62 (“N conversion” in the figure). The memory 62 stores the reset signal after the AD conversion output from the AD conversion circuit 61.

At time t5b, the vertical scanning circuit 20 controls the control signal φRESL0 from high level to low level, and controls the control signal φRESL1 from low level to high level. The transistor M7 of the buffer circuit 30A is turned off and the transistor M8 thereof is turned on. The voltage VRESL1 (for example, 0.6 V) is supplied to the gate of the reset transistor M2 of the unit pixel 11 as the control signal φRES_O via the transistor M8. The reset transistor M2 functions as a clip transistor that limits the amplitude of the pixel signal at the FD clip level according to the gate voltage (for example, 0.6 V). The FD clip level is determined by the gate voltage of the reset transistor M2, and as the voltage of the control signal φRES_O rises from the voltage VRESL0 (for example, 0 V) to the voltage VRESL1 (for example, 0.6 V), the FD clip level also rises.

At time t6b, the column signal line clip circuit 40 lowers the VL clip level than the FD clip level. At the same time t6b, the vertical scanning circuit 20 controls the control signal φTX_O from low level to high level. The transfer transistor M1 of the unit pixel 11 is turned on, and the charge accumulated in the photoelectric conversion element PD is transferred to the input node FD. The transferred charge is further added to the charge already overflowing from the photoelectric conversion element PD to the input node FD, and the voltage of the input node FD further decreases. When the voltage of the input node FD decreases, the reset transistor M2 is temporarily turned on, and the voltage of the input node FD is limited to the FD clip level based on the voltage VRESL1. Further, since the VL clip level is controlled to be lower than the FD clip level, the voltage of the column signal line 13 is also limited to the FD clip level.

At time t7b, the vertical scanning circuit 20 controls the control signal φTX_O from high level to low level. The transfer transistor M1 of the unit pixel 11 is turned off, and the transfer of the charge from the photoelectric conversion element PD to the input node FD is stopped.

At time t8b, the vertical scanning circuit 20 controls the control signal φRESL1 from high level to low level, and controls the control signal φRESL0 from low level to high level. The transistor M8 of the buffer circuit 30A is turned off, and the transistor M7 is turned on. The voltage VRESL0 (for example, 0 V) is supplied to the gate of the reset transistor M2 of the unit pixel 11 as the control signal φRES_O via the transistor M7. The reset transistor M2 functions as a clip transistor that limits the amplitude of the pixel signal at the FD clip level according to the gate voltage (for example, 0 V). The FD clip level is determined by the gate voltage of the reset transistor M2, and when the voltage of the control signal φRES_O decreases from the voltage VRESL1 (for example, 0.6 V) to the voltage VRESL0 (for example, 0 V), the FD clip level also decreases. At this time, the charge of the input node FD is already discharged to the power supply (voltage VDD), and the voltage of the column signal line 13 does not change significantly.

At time t9b, the photoelectric conversion element PD becomes saturated, and the charge starts to overflow from the photoelectric conversion element PD to the input node FD again. The voltages of the input node FD and the column signal line 13 start to decrease, and the decrease of the voltages of the input node FD and the column signal line 13 stops at the FD clip level based on the voltage VRESL0. An amount of the voltage drop of the column signal line 13 is determined by the voltage difference between the voltage VRES1 and the voltage VRESL0. When the illuminance is not high such that the charge overflows to the input node FD again immediately after the transfer of the charge, the amplitude of the column signal line 13 is limited at the FD clip level based on the voltage VRESL1.

From time t10b to time t11b, the AD conversion circuit 61 performs AD conversion of the pixel signal and outputs the pixel signal after the AD conversion to the memory 62 (in the figure, “S conversion”). The memory 62 stores the pixel signal after the AD conversion output from the AD conversion circuit 61. The horizontal scanning circuit 70 sequentially scans the memories 62, and outputs the reset signal and the pixel signal after the AD conversion held in each of the memories 62 to the signal processing circuit 80. The signal processing circuit 80 subtracts the reset signal from the pixel signal, extracts only a signal corresponding to the amount of incident light, and outputs the extracted signal to the outside of the photoelectric conversion device.

At time t12b, the vertical scanning circuit 20 controls the control signal φRESn from high level to low level. The P-type MOS transistor M5 of the buffer circuit 30A is turned on, and the control signal φRES_O output from the buffer circuit 30A becomes high level (voltage VRESH). The voltage VRESH is supplied to the gate of the reset transistor M2, the reset transistor M2 is turned on, and the input node FD (Cfd+C1+C2) is reset to a voltage (reset voltage) of a reset level corresponding to the voltage VDD.

At time t13b, the vertical scanning circuit 20 controls the control signal φSEL_O from high level to low level. The selection transistor M4 of the unit pixel 11 is turned off, the amplification transistor M3 of the unit pixel 11 is disconnected from the column signal line 13, and the reading of the signals of the unit pixels 11 of the two rows to be read simultaneously ends. As described above, in the case of driving for the low-gain high illuminance, the FD clip level is controlled by switching low level of the control signal φRES_O between the voltage VRESL0 and the voltage VRESL1.

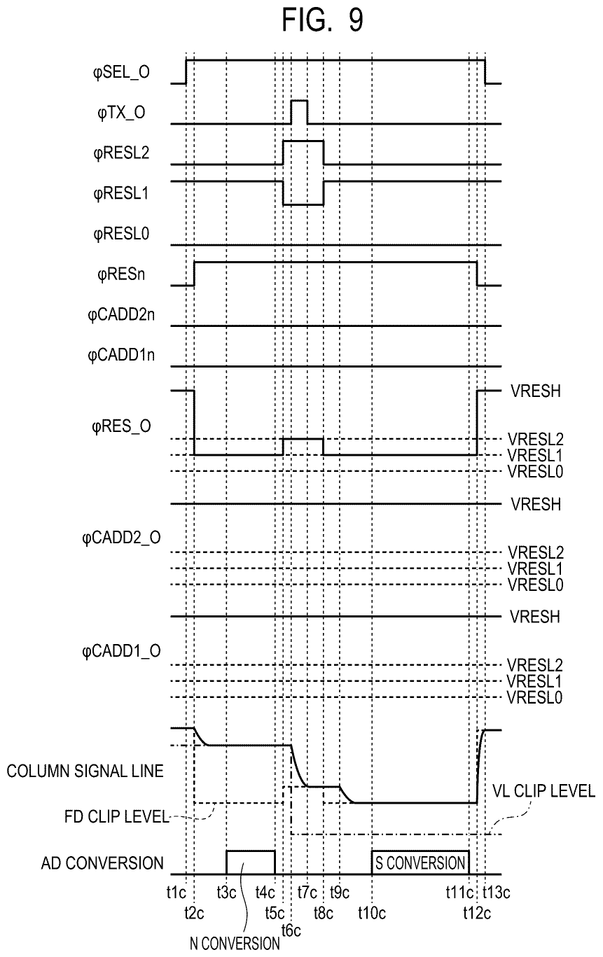

Next, a low-gain low illuminance driving mode of the photoelectric conversion device will be described with reference to FIG. 9. FIG. 9 is a timing chart illustrating an operation example of the photoelectric conversion device in the low-gain low illuminance driving mode according to the present embodiment. The low-gain and low illuminance driving mode is different from the low-gain high illuminance driving mode illustrated in FIG. 8 in that the FD clip level is increased, and the same processing is executed in other modes.

In the case of the low-gain low illuminance driving mode, immediately before time t1c illustrated in FIG. 9, the control signals φCADD1n and φCADD2n are at low level. The control signal φCADD1_O and the control signal φCADD2_O output from the buffer circuit 30A become high level (voltage VRESH), and the voltage VRESH is supplied to the gates of the first and second capacitance addition transistors M2a and M2b. The first and second capacitance addition transistors M2a and M2b are turned on, and the capacitance of the input node FD becomes Cfd+C1+C2 (capacitance “large”). The gain in the charge-voltage conversion becomes “low gain”. Therefore, the amplitude of the signal at the input node FD becomes small, and the pixel signal can be converted from analog to digital without being clipped even for a subject with higher illuminance. Immediately before time t1c, since the control signal φRESn is at low level, the control signal φRES_O output from the buffer circuit 30A is at high level (voltage VRESH). Since the voltage VRESH is supplied to the gate of the reset transistor M2, the reset transistor M2 is turned on, and the input node FD is reset to a voltage (reset voltage) of a reset level corresponding to the voltage VDD.

At time t1c illustrated in FIG. 9, the vertical scanning circuit 20 controls the control signal SEL_O from low level to high level for the target unit pixel 11 (the unit pixels 11 of two rows) in the pixel unit 10. The selection transistor M4 of the target unit pixel 11 is turned on, and the amplification transistor M3 of the target unit pixel 11 is connected to the column signal line 13 via the selection transistor M4. As a result, a bias current is supplied from the current source 50 to the amplification transistor M3 via the column signal line 13 and the selection transistor M4, and a reset signal corresponding to the reset voltage of the input node FD is output to the column signal line 13 via the selection transistor M4. The readout of the reset signal is started for the unit pixels 11 of the two rows simultaneously read out.

At time t2c, the vertical scanning circuit 20 controls the control signal φRESn from low level to high level. The N-type MOS transistor M6 of the buffer circuit 30A is turned on, and the control signal φRES_O output from the buffer circuit 30A becomes low level. At this time, since the control signals φRESL0 and φRESL2 are at low level and the control signal φRESL1 is at high level, the transistors M7 and M9 of the buffer circuit 30A are turned off and the transistor M8 is turned on. The gate of the reset transistor M2 is supplied with a voltage VRESL1 (for example, 0.6 V) as a control signal φRES_O via the transistor M8. The reset transistor M2 of the unit pixel 11 is turned off, and the input node FD is disconnected from the power supply (voltage VDD) and enters a floating state.

Here, a state is illustrated in which high illuminance light is incident on the unit pixel 11, the charge that can be accumulated in the photoelectric conversion element PD is saturated, and the charge overflows from the photoelectric conversion element PD to the input node FD. Since the charge overflows to the input node FD in this manner, the voltage of the column signal line 13 decreases. During the readout period of the reset signal (time t2c to time t6c), since the VL clip level is higher than the FD clip level, the voltage of the column signal line 13 stops decreasing at the VL clip level.

From time t3c to time t4c, the AD conversion circuit 61 performs AD conversion of the reset signal, and outputs the reset signal after the AD conversion to the memory 62 (“N conversion” in the figure). The memory 62 stores the reset signal after the AD conversion output from the AD conversion circuit 61.

At time t5c, the vertical scanning circuit 20 controls the control signal φRESL1 from high level to low level, and controls the control signal φRESL2 from low level to high level. The transistor M8 of the buffer circuit 30A is turned off, and the transistor M9 is turned on. The voltage VRESL2 (for example, 1.2 V) is supplied to the gate of the reset transistor M2 of the unit pixel 11 as the control signal φRES_O via the transistor M9. The reset transistor M2 functions as a clip transistor that limits the amplitude of the pixel signal at the FD clip level according to the gate voltage (for example, 1.2 V). The FD clip level is determined by the gate voltage of the reset transistor M2, and the FD clip level also rises as the voltage of the control signal φRES_O rises from the voltage VRESL1 (for example, 0.6 V) to the voltage VRESL2 (for example, 1.2 V).

At time toc, the column signal line clip circuit 40 lowers the VL clip level than the FD clip level. At the same time toc, the vertical scanning circuit 20 controls the control signal φTX_O from low level to high level. The transfer transistor M1 of the unit pixel 11 is turned on, and the charge accumulated in the photoelectric conversion element PD is transferred to the input node FD. The transferred charge is further added to the charge already overflowing from the photoelectric conversion element PD to the input node FD, and the voltage of the input node FD further decreases. When the voltage of the input node FD decreases, the reset transistor M2 is temporarily turned on, and the voltage of the input node FD is limited to the FD clip level based on the voltage VRESL2. Further, the VL clip level is controlled to be lower than the FD clip level, and the voltage of the column signal line 13 is also limited to the FD clip level.

At time t7c, the vertical scanning circuit 20 controls the control signal φTX_O from high level to low level. The transfer transistor M1 of the unit pixel 11 is turned off, and the transfer of the charge from the photoelectric conversion element PD to the input node FD is stopped.

At time t8c, the vertical scanning circuit 20 controls the control signal φRESL2 from high level to low level, and controls the control signal RESL1 from low level to high level. The transistor M9 of the buffer circuit 30A is turned off, and the transistor M8 is turned on. The voltage VRESL1 (for example, 0.6 V) is supplied to the gate of the reset transistor M2 of the unit pixel 11 as the control signal φRES_O via the transistor M8. The reset transistor M2 functions as a clip transistor that limits the amplitude of the pixel signal at the FD clip level according to the gate voltage (for example, 0.6 V). Since the FD clip level is determined by the gate voltage of the reset transistor M2, the FD clip level also decreases as the voltage of the control signal φRES_O decreases from the voltage VRESL2 (for example, 1.2 V) to the voltage VRESL1 (for example, 0.6 V). At this time, since the charge of the input node FD has already been discharged to the power supply (voltage VDD), the voltage of the column signal line 13 does not change significantly.

At time t9c, the photoelectric conversion element PD becomes saturated, and the charge starts to overflow from the photoelectric conversion element PD to the input node FD again. The voltages of the input node FD and the column signal line 13 start to decrease, and the decrease of the voltages of the input node FD and the column signal line 13 stops at the FD clip level based on the voltage VRESL1. An amount of the voltage drop of the column signal line 13 is determined by the voltage difference between the voltage VRES2 and the voltage VRESL1. When the illuminance is not high such that the charge overflows to the input node FD again immediately after the transfer of the charge, the amplitude of the column signal line 13 is limited at the FD clip level based on the voltage VRESL2.

From time t10c to time t11c, the AD conversion circuit 61 performs AD conversion of the pixel signal and outputs the pixel signal after the AD conversion to the memory 62 (in the figure, “S conversion”). The memory 62 stores the pixel signal after the AD conversion output from the AD conversion circuit 61. The horizontal scanning circuit 70 sequentially scans the memories 62, and outputs the reset signal and the pixel signal after the AD conversion held in each of the memories 62 to the signal processing circuit 80. The signal processing circuit 80 subtracts the reset signal from the pixel signal, extracts only a signal corresponding to the amount of incident light, and outputs the extracted signal to the outside of the photoelectric conversion device.

At time t12c, the vertical scanning circuit 20 controls the control signal φRESn from high level to low level. The P-type MOS transistor M5 of the buffer circuit 30A is turned on, and the control signal φRES_O output from the buffer circuit 30A becomes high level (voltage VRESH). Since the voltage VRESH is supplied to the gate of the reset transistor M2, the reset transistor M2 is turned on, and the input node FD is reset to a voltage (reset voltage) of a reset level corresponding to the voltage VDD.

At time t13c, the vertical scanning circuit 20 controls the control signal φSEL_O from high level to low level. The selection transistor M4 of the unit pixel 11 is turned off, the amplification transistor M3 of the unit pixel 11 is disconnected from the column signal line 13, and the reading of the signals of the unit pixels 11 of the two rows to be read simultaneously ends. As described above, in the case of driving for the low-gain low illuminance, the FD clip level is controlled by switching low level of the control signal φRES_O between the voltages VRESL1 and VRESL2.

As described above, even in the low gain state in which the capacitance of the input node FD is added in two stages, it is possible to prevent the influence of the fluctuation of the pixel signal due to the overflow of the charge from the photoelectric conversion element PD after the charge transfer from degrading in the low illuminance driving mode.

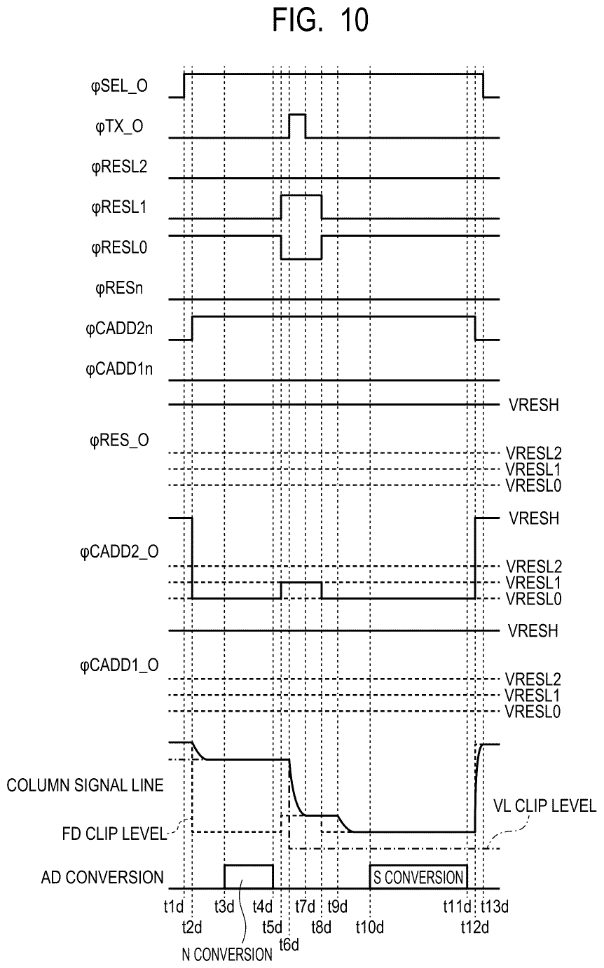

Next, a medium-gain high illuminance driving mode by the photoelectric conversion device will be described with reference to FIG. 10. FIG. 10 is a timing chart illustrating an operation example of the photoelectric conversion device in the medium-gain high illuminance driving mode according to the present embodiment.

In the case of the medium-gain high illuminance driving mode, immediately before time t1d illustrated in FIG. 10, the control signals φRESn, φCADD1n, and φCADD2n are at low level. Therefore, the control signals φRES_O, φCADD1_O, and φCADD2_O output from the buffer circuit 30A become high level (voltage VRESH). Then, the voltage VRESH is supplied to the gates of the reset transistor M2, the first capacitance addition transistor M2a, and the second capacitance addition transistor M2b. The reset transistor M2, the first capacitance addition transistor M2a, and the second capacitance addition transistor M2b are turned on, and the input node FD (Cfd+C1+C2) is reset to a voltage (reset voltage) of a reset level corresponding to the voltage VDD. At time t1d illustrated in FIG. 10, the vertical scanning circuit 20 controls the control signal φSEL_O from low level to high level for the target unit pixel 11 (the unit pixels 11 of two rows) in the pixel unit 10. The selection transistor M4 of the target unit pixel 11 is turned on, and the amplification transistor M3 of the target unit pixel 11 is connected to the column signal line 13 via the selection transistor M4. As a result, a bias current is supplied from the current source 50 to the amplification transistor M3 via the column signal line 13 and the selection transistor M4, and a reset signal corresponding to the reset voltage of the input node FD is output to the column signal line 13 via the selection transistor M4. The readout of the reset signal is started for the unit pixels 11 of the two rows simultaneously read out.

At time t2d, the vertical scanning circuit 20 controls the control signal φCADD2n from low level to high level. The N-type MOS transistor M6b of the buffer circuit 30A is turned on, and the control signal φCADD2_O output from the buffer circuit 30A becomes low level. At this time, since the control signals φRESL1 and φRESL2 are at low level and the control signal RESL0 is at high level, the transistors M8 and M9 of the buffer circuit 30A are turned off and the transistor M7 is turned on. The voltage VRESL0 (for example, 0 V) is supplied to the gate of the second capacitance addition transistor M2b as the control signal φCADD2_O via the transistor M7. The second capacitance addition transistor M2b of the unit pixel 11 is turned off, and the input node FD is disconnected from the power supply (voltage VDD) and enters a floating state. At this time, since the first capacitance addition transistor M2a is turned on and the second capacitance addition transistor M2b is turned off, the input node FD becomes the capacitance Cfd+C1 (capacitance “medium”). The gain in the charge-voltage conversion becomes “medium gain”. Therefore, the amplitude of the signal at the input node FD is more likely to be limited than in the case of “low gain”. However, since the amplitude of the signal of the same charge amount becomes large, the noise of the amplification transistor M3 and the noise due to the AD conversion become relatively small, and the SN ratio with respect to the low illuminance signal is improved.

Here, a state is illustrated in which high illuminance light is incident on the unit pixel 11, the charge that can be accumulated in the photoelectric conversion element PD is saturated, and the charge overflows from the photoelectric conversion element PD to the input node FD. Since the charge overflows to the input node FD in this manner, the voltage of the column signal line 13 decreases. During the readout period of the reset signal (time t2d to time t6d), since the VL clip level is higher than the FD clip level, the voltage of the column signal line 13 stops decreasing at the VL clip level.

From time t3d to time t4d, the AD conversion circuit 61 performs AD conversion of the reset signal, and outputs the reset signal after the AD conversion to the memory 62 (“N conversion” in the figure). The memory 62 stores the reset signal after the AD conversion output from the AD conversion circuit 61.

At time t5d, the vertical scanning circuit 20 controls the control signal φRESL0 from high level to low level, and controls the control signal φRESL1 from low level to high level. The transistor M7 of the buffer circuit 30A is turned off, and the transistor M8 is turned on. The voltage VRESL1 (for example, 0.6 V) is supplied to the gate of the second capacitance addition transistor M2b of the unit pixel 11 as the control signal φCADD2_O via the transistor M8. The second capacitance addition transistor M2b functions as a clip transistor that limits the amplitude of the pixel signal at the FD clip level according to the gate voltage (for example, 0.6 V). Since the FD clip level is determined by the gate voltage of the second capacitance addition transistor M2b, the FD clip level also rises as the voltage of the control signal φCADD2_O rises from the voltage VRESL0 (for example, 0 V) to the voltage VRESL1 (for example, 0.6 V).

At time t6d, the column signal line clip circuit 40 lowers the VL clip level than the FD clip level. At the same time t6d, the vertical scanning circuit 20 controls the control signal φTX_O from low level to high level. The transfer transistor M1 of the unit pixel 11 is turned on, and the charge accumulated in the photoelectric conversion element PD is transferred to the input node FD. The transferred charge is further added to the charge already overflowing from the photoelectric conversion element PD to the input node FD, and the voltage of the input node FD further decreases. When the voltage of the input node FD decreases, the second capacitance addition transistor M2b is temporarily turned on, and the voltage of the input node FD is limited to the FD clip level based on the voltage VRESL1. Further, the VL clip level is controlled to be lower than the FD clip level, and the voltage of the column signal line 13 is also limited to the FD clip level.

At time t7d, the vertical scanning circuit 20 controls the control signal φTX_O from high level to low level. The transfer transistor M1 of the unit pixel 11 is turned off, and the transfer of the charge from the photoelectric conversion element PD to the input node FD is stopped.

At time t8d, the vertical scanning circuit 20 controls the control signal φRESL1 from high level to low level, and controls the control signal φRESL0 from low level to high level. The transistor M8 of the buffer circuit 30A is turned off, and the transistor M7 is turned on. The voltage VRESL0 (for example, 0 V) is supplied to the gate of the second capacitance addition transistor M2b of the unit pixel 11 as the control signal φCADD2_O via the transistor M7. The second capacitance addition transistor M2b functions as a clip transistor that limits the amplitude of the pixel signal at the FD clip level according to the gate voltage (for example, 0 V). The FD clip level is determined by the gate voltage of the second capacitance addition transistor M2b, and the FD clip level also decreases as the voltage of the control signal φCADD2_O decreases from the voltage VRESL1 (for example, 0.6 V) to the voltage VRESL0 (for example, 0 V). At this time, since the charge of the input node FD has already been discharged to the power supply (voltage VDD), the voltage of the column signal line 13 does not change significantly.

At time t9d, the photoelectric conversion element PD becomes saturated, and the charge starts to overflow from the photoelectric conversion element PD to the input node FD again. The voltages of the input node FD and the column signal line 13 start to decrease, and the decrease of the voltages of the input node FD and the column signal line 13 is stopped at the FD clip level based on the voltage VRESL0. An amount of the voltage drop of the column signal line 13 is determined by the voltage difference between the voltage VRES1 and the voltage VRESL0. When the illuminance is not high such that the charge overflows to the input node FD again immediately after the transfer of the charge, the amplitude of the column signal line 13 is limited at the FD clip level based on the voltage VRESL1.

From time t10d to time t11d, the AD conversion circuit 61 performs AD conversion of the pixel signal and outputs the pixel signal after the AD conversion to the memory 62 (in the figure, “S conversion”). The memory 62 stores the pixel signal after the AD conversion output from the AD conversion circuit 61. The horizontal scanning circuit 70 sequentially scans the memories 62, and outputs the reset signal and the pixel signal after the AD conversion held in each of the memories 62 to the signal processing circuit 80. The signal processing circuit 80 subtracts the reset signal from the pixel signal, extracts only a signal corresponding to the amount of incident light, and outputs the extracted signal to the outside of the photoelectric conversion device.

At time t12d, the vertical scanning circuit 20 controls the control signal φCADD2n from high level to low level. The P-type MOS transistor M5b of the buffer circuit 30A is turned on, and the control signal φCADD2_O output from the buffer circuit 30A becomes high level (voltage VRESH). Since the voltage VRESH is supplied to the gate of the second capacitance addition transistor M2b, the second capacitance addition transistor M2b is turned on, and the input node FD (Cfd+C1+C2) is reset to a voltage (reset voltage) of a reset level corresponding to the voltage VDD.

At time t13d, the vertical scanning circuit 20 controls the control signal φSEL_O from high level to low level. The selection transistor M4 of the unit pixel 11 is turned off, the amplification transistor M3 of the unit pixel 11 is disconnected from the column signal line 13, and the reading of the signals of the unit pixels 11 of the two rows to be read simultaneously ends. As described above, in the case of driving for the medium-gain high illuminance, low level of the control signal φCADD2_O is switched between the voltage VRESL0 and the voltage VRESL1.

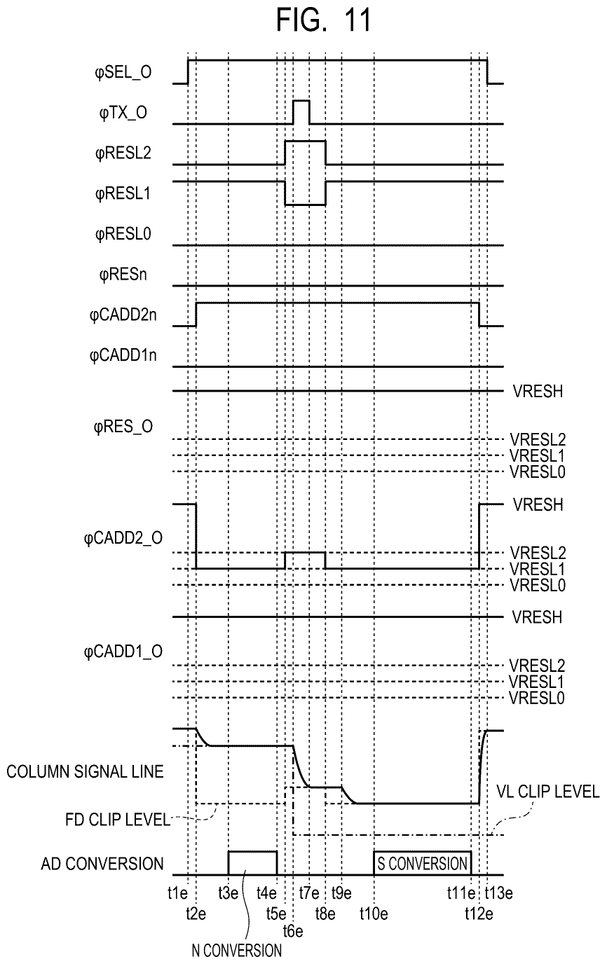

Next, a medium-gain low illuminance driving mode by the photoelectric conversion device will be described with reference to FIG. 11. FIG. 11 is a timing chart illustrating an operation example of the photoelectric conversion device in the medium-gain low illuminance driving mode according to the present embodiment. The medium-gain low illuminance driving mode is different from the medium-gain high illuminance driving mode illustrated in FIG. 10 in that the FD clip level is increased, and the same processing is executed in other modes.

In the case of the medium-gain low illuminance driving mode, immediately before time t1e illustrated in FIG. 11, the control signals φRESn, φCADD1n, and φCADD2n are at low level. The control signals φRES_O, φCADD1_O, and φCADD2_O output from the buffer circuit 30A become high level (voltage VRESH). Then, the voltage VRESH is supplied to the gates of the reset transistor M2, the first capacitance addition transistor M2a, and the second capacitance addition transistor M2b. The reset transistor M2, the first capacitance addition transistor M2a, and the second capacitance addition transistor M2b are turned on, and the input node FD (Cfd+C1+C2) is reset to a voltage (reset voltage) of a reset level corresponding to the voltage VDD.

At time t1e illustrated in FIG. 11, the vertical scanning circuit 20 controls the control signal φSEL_O from low level to high level for the target unit pixel 11 (the unit pixels 11 of two rows) in the pixel unit 10. The selection transistor M4 of the target unit pixel 11 is turned on, and the amplification transistor M3 of the target unit pixel 11 is electrically connected to the column signal line 13 via the selection transistor M4. As a result, a bias current is supplied from the current source 50 to the amplification transistor M3 via the column signal line 13 and the selection transistor M4, and a reset signal corresponding to the reset voltage of the input node FD is output to the column signal line 13 via the selection transistor M4. The readout of the reset signal is started for the unit pixels 11 of the two rows simultaneously read out.

At time t2e, the vertical scanning circuit 20 controls the control signal φCADD2n from low level to high level. The N-type MOS transistor M6b of the buffer circuit 30A is turned on, and the control signal φCADD2_O output from the buffer circuit 30A becomes low level. At this time, the control signals φRESL0 and φRESL2 are at low level and the control signal φRESL1 is at high level, and the transistors M7 and M9 of the buffer circuit 30A are turned off and the transistor M8 is turned on. The voltage VRESL1 (for example, 0.6 V) is supplied to the gate of the second capacitance addition transistor M2b as the control signal φCADD2_O via the transistor M8. The second capacitance addition transistor M2b of the unit pixel 11 is turned off, and the input node FD is disconnected from the power supply (voltage VDD) and enters a floating state. At this time, the first capacitance addition transistor M2a is turned on, the second capacitance addition transistor M2b is turned off, and the input node FD becomes the capacitance Cfd+C1 (capacitance “medium”). The gain in the charge-voltage conversion is “middle gain”. Therefore, the amplitude of the signal at the input node FD is more likely to be limited than in the case of “low gain”. However, since the amplitude of the signal of the same charge amount becomes large, the noise of the amplification transistor M3 and the noise due to the AD conversion become relatively small, and the S/N ratio with respect to the low illuminance signal is improved.

Here, a state is illustrated in which high illuminance light is incident on the unit pixel 11, the charge that can be accumulated in the photoelectric conversion element PD is saturated, and the charge overflows from the photoelectric conversion element PD to the input node FD. Since the charge overflows to the input node FD in this manner, the voltage of the column signal line 13 decreases. During the readout period of the reset signal (time t2e to time toe), since the VL clip level is higher than the FD clip level, the voltage of the column signal line 13 stops decreasing at the VL clip level.

From time t3e to time t4e, the AD conversion circuit 61 performs AD conversion of the reset signal and outputs the reset signal after the AD conversion to the memory 62 (“N conversion” in the figure). The memory 62 stores the reset signal after the AD conversion output from the AD conversion circuit 61.

At time t5e, the vertical scanning circuit 20 controls the control signal φRESL1 from high level to low level, and controls the control signal φRESL2 from low level to high level. The transistor M8 of the buffer circuit 30A is turned off, and the transistor M9 is turned on. The voltage VRESL2 (for example, 1.2 V) is supplied to the gate of the second capacitance addition transistor M2b of the unit pixel 11 as the control signal φCADD2_O via the transistor M9. The second capacitance addition transistor M2b functions as a clip transistor that limits the amplitude of the pixel signal at the FD clip level according to the gate voltage (for example, 1.2 V). The FD clip level is determined by the gate voltage of the second capacitance addition transistor M2b, and the FD clip level also rises as the voltage of the control signal φCADD2_O rises from the voltage VRESL1 (for example, 0.6 V) to the voltage VRESL2 (for example, 1.2 V).

At time toe, the column signal line clip circuit 40 lowers the VL clip level than the FD clip level. At the same time toe, the vertical scanning circuit 20 controls the control signal φTX_O from low level to high level. The transfer transistor M1 of the unit pixel 11 is turned on, and the charge accumulated in the photoelectric conversion element PD is transferred to the input node FD. The transferred charge is further added to the charge already overflowing from the photoelectric conversion element PD to the input node FD, and the voltage of the input node FD further decreases. When the voltage of the input node FD decreases, the second capacitance addition transistor M2b is temporarily turned on, and the voltage of the input node FD is limited to the FD clip level based on the voltage VRESL2. Further, since the VL clip level is controlled to be lower than the FD clip level, the voltage of the column signal line 13 is also limited to the FD clip level.

At time t7e, the vertical scanning circuit 20 controls the control signal φTX_O from high level to low level. The transfer transistor M1 of the unit pixel 11 is turned off, and the transfer of the charge from the photoelectric conversion element PD to the input node FD is stopped.

At time t8e, the vertical scanning circuit 20 controls the control signal φRESL2 from high level to low level, and controls the control signal φRESL1 from low level to high level. The transistor M9 of the buffer circuit 30A is turned off, and the transistor M8 is turned on. The voltage VRESL1 (for example, 0.6 V) is supplied to the gate of the second capacitance addition transistor M2b of the unit pixel 11 as the control signal φCADD2_O via the transistor M8. The second capacitance addition transistor M2b functions as a clip transistor that limits the amplitude of the pixel signal at the FD clip level according to the gate voltage (for example, 0.6 V). Since the FD clip level is determined by the gate voltage of the second capacitance addition transistor M2b, the FD clip level also decreases as the voltage of the control signal φCADD2_O decreases from the voltage VRESL2 (for example, 1.2 V) to the voltage VRESL1 (for example, 0.6 V). At this time, since the charge of the input node FD has already been discharged to the power supply (voltage VDD), the voltage of the column signal line 13 does not change significantly.

At time t9e, the photoelectric conversion element PD becomes saturated, and the charge starts to overflow from the photoelectric conversion element PD to the input node FD again. The voltages of the input node FD and the column signal line 13 start to decrease, and the decrease of the voltages of the input node FD and the column signal line 13 stops at the FD clip level based on the voltage VRESL1. An amount of the voltage drop of the column signal line 13 is determined by the voltage difference between the voltage VRES2 and the voltage VRESL1. When the illuminance is not high such that the charge overflows to the input node FD again immediately after the transfer of the charge, the amplitude of the column signal line 13 is limited at the FD clip level based on the voltage VRESL2.

From time t10e to time t11e, the AD conversion circuit 61 performs AD conversion of the pixel signal and outputs the pixel signal after the AD conversion to the memory 62 (in the figure, “S conversion”). The memory 62 stores the pixel signal after the AD conversion output from the AD conversion circuit 61. The horizontal scanning circuit 70 sequentially scans the memories 62, and outputs the reset signal and the pixel signal after the AD conversion held in each of the memories 62 to the signal processing circuit 80. The signal processing circuit 80 subtracts the reset signal from the pixel signal and outputs a signal corresponding to the amount of incident light to the outside of the photoelectric conversion device.

At time t12e, the vertical scanning circuit 20 controls the control signal φCADD2n from high level to low level. The P-type MOS transistor M5b of the buffer circuit 30A is turned on, and the control signal φCADD2_O output from the buffer circuit 30A becomes high level (voltage VRESH). The voltage VRESH is supplied to the gate of the second capacitance addition transistor M2b, the second capacitance addition transistor M2b is turned on, and the input node FD is reset to a voltage (reset voltage) of a reset level corresponding to the voltage VDD.

At time t13e, the vertical scanning circuit 20 controls the control signal φSEL_O from high level to low level. The selection transistor M4 of the unit pixel 11 is turned off, the amplification transistor M3 of the unit pixel 11 is disconnected from the column signal line 13, and the reading of the signals of the unit pixels 11 of the two rows to be read simultaneously ends. As described above, in the case of driving for the medium-gain low illuminance, low level of the control signal φCADD2_O is switched between the voltages VRESL1 and VRESL2.

As described above, even in the medium gain state in which the capacitance of the input node FD is added in one step, it is possible to prevent the influence of fluctuation of the pixel signal due to overflow of the charge from the photoelectric conversion element PD after the charge transfer from degrading in the low illuminance drive mode.

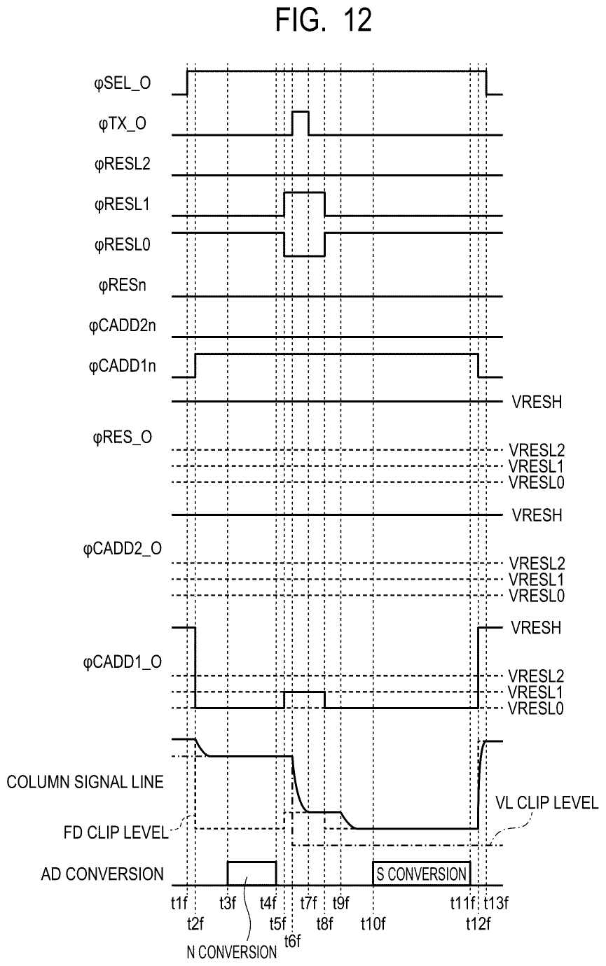

Next, a high-gain high illuminance driving mode of the photoelectric conversion device will be described with reference to FIG. 12. FIG. 12 is a timing chart illustrating an operation example of the photoelectric conversion device in the high-gain high illuminance driving mode according to the present embodiment.

In the high-gain high illuminance driving mode, immediately before time t1f illustrated in FIG. 12, the control signals φRESn, φCADD1n, and CADD2n are at low level. The control signals φRES_O, φCADD1_O, and φCADD2_O output from the buffer circuit 30A become high level (voltage VRESH). Then, the voltage VRESH is supplied to the gates of the reset transistor M2, the first capacitance addition transistor M2a, and the second capacitance addition transistor M2b. The reset transistor M2, the first capacitance addition transistor M2a, and the second capacitance addition transistor M2b are turned on, and the input node FD (Cfd+C1+C2) is reset to a voltage (reset voltage) of a reset level corresponding to the voltage VDD.

At time t1f illustrated in FIG. 12, the vertical scanning circuit 20 controls the control signal SEL_O from low level to high level for the target unit pixel 11 (the unit pixels 11 of two rows) in the pixel unit 10. The selection transistor M4 of the target unit pixel 11 is turned on, and the amplification transistor M3 of the target unit pixel 11 is connected to the column signal line 13 via the selection transistor M4. As a result, a bias current is supplied from the current source 50 to the amplification transistor M3 via the column signal line 13 and the selection transistor M4, and a reset signal corresponding to the reset voltage of the input node FD is output to the column signal line 13 via the selection transistor M4. The readout of the reset signal is started for the unit pixels 11 of the two rows simultaneously read out.

At time t2f, the vertical scanning circuit 20 controls the control signal φCADD1n from low level to high level. The N-type MOS transistor M6a of the buffer circuit 30A is turned on, and the control signal φCADD1_O output from the buffer circuit 30A becomes low level. At this time, the control signals φRESL1 and φRESL2 are at low level and the control signal φRESL0 is at high level, and the transistors M8 and M9 of the buffer circuit 30A are turned off and the transistor M7 is turned on. The voltage VRESL0 (for example, 0 V) is supplied to the gate of the first capacitance addition transistor M2a as the control signal φCADD1_O via the transistor M7. The first capacitance addition transistor M2a of the unit pixel 11 is turned off, and the input node FD is disconnected from the power supply (voltage VDD) and enters a floating state. At this time, the first capacitance addition transistor M2a is turned off, and the input node FD becomes the capacitance Cfd (capacitance “small”). The gain in the charge-voltage conversion is “high gain”. As compared with the case of the “medium gain”, the amplitude of the signal at the input node FD is easily limited. However, since the amplitude of the signal of the same charge amount becomes large, the noise of the amplification transistor M3 and the noise due to the AD conversion become relatively smaller, and the S/N ratio with respect to the low illuminance signal is improved.

Here, a state is illustrated in which high illuminance light is incident on the unit pixel 11, the charge that can be accumulated in the photoelectric conversion element PD is saturated, and the charge overflows from the photoelectric conversion element PD to the input node FD. In this way, the charge overflows to the input node FD, and the voltage of the column signal line 13 decreases. During the readout period of the reset signal (from time t2f to time t6f), since the VL clip level is higher than the FD clip level, the voltage of the column signal line 13 stops decreasing at the VL clip level.

From time t3f to time t4f, the AD conversion circuit 61 performs AD conversion of the reset signal, and outputs the reset signal after the AD conversion to the memory 62 (“N conversion” in the figure). The memory 62 stores the reset signal after the AD conversion output from the AD conversion circuit 61.

At time t5f, the vertical scanning circuit 20 controls the control signal φRESL0 from high level to low level, and controls the control signal φRESL1 from low level to high level. The transistor M7 of the buffer circuit 30A is turned off, and the transistor M8 is turned on. The voltage VRESL1 (for example, 0.6 V) is supplied to the gate of the second capacitance addition transistor M2b of the unit pixel 11 as the control signal φCADD1_O via the transistor M8. The first capacitance addition transistor M2a functions as a clip transistor that limits the amplitude of the pixel signal at the FD clip level according to the gate voltage (for example, 0.6 V). The FD clip level is determined by the gate voltage of the first capacitance addition transistor M2a, and the FD clip level also rises as the voltage of the control signal φCADD1_O rises from the voltage VRESL0 (for example, 0 V) to the voltage VRESL1 (for example, 0.6 V).

At time t6f, the column signal line clip circuit 40 lowers the VL clip level than the FD clip level. At the same time t6f, the vertical scanning circuit 20 controls the control signal φTX_O from low level to high level. The transfer transistor M1 of the unit pixel 11 is turned on, and the charge accumulated in the photoelectric conversion element PD is transferred to the input node FD. The transferred charge is further added to the charge already overflowing from the photoelectric conversion element PD to the input node FD, and the voltage of the input node FD further decreases. When the voltage of the input node FD decreases, the first capacitance addition transistor M2a is temporarily turned on, and the voltage of the input node FD is limited to the FD clip level based on the voltage VRESL1. Further, the VL clip level is controlled to be lower than the FD clip level, and the voltage of the column signal line 13 is also limited to the FD clip level.

At time t7f, the vertical scanning circuit 20 controls the control signal φTX_O from high level to low level. The transfer transistor M1 of the unit pixel 11 is turned off, and the transfer of the charge from the photoelectric conversion element PD to the input node FD is stopped.

At time t8f, the vertical scanning circuit 20 controls the control signal φRESL1 from high level to low level, and controls the control signal φRESL0 from low level to high level. The transistor M8 of the buffer circuit 30A is turned off, and the transistor M7 is turned on. A voltage VRESL0 (for example, 0 V) is supplied to the gate of the first capacitance addition transistor M2a of the unit pixel 11 as the control signal φCADD1_O via the transistor M7. The first capacitance addition transistor M2a functions as a clip transistor that limits the amplitude of the pixel signal at the FD clip level according to the gate voltage (for example, 0 V). The FD clip level is determined by the gate voltage of the first capacitance addition transistor M2a, and the FD clip level also decreases as the voltage of the control signal φCADD1_O decreases from the voltage VRESL1 (for example, 0.6 V) to the voltage VRESL0 (for example, 0 V). At this time, the charge of the input node FD is already discharged to the power supply (voltage VDD), and the voltage of the column signal line 13 does not change significantly.

At time t9f, the photoelectric conversion element PD becomes saturated, and the charge starts to overflow from the photoelectric conversion element PD to the input node FD again. The voltages of the input node FD and the column signal line 13 start to decrease, and the decrease of the voltages of the input node FD and the column signal line 13 stops at the FD clip level based on the voltage VRESL0. An amount of the voltage drop of the column signal line 13 is determined by the voltage difference between the voltage VRES1 and the voltage VRESL0. When the illuminance is not high such that the charge overflows to the input node FD again immediately after the transfer of the charge, the amplitude of the column signal line 13 is limited at the FD clip level based on the voltage VRESL1.

From time t10f to time t11f, the AD conversion circuit 61 performs AD conversion of the pixel signal and outputs the pixel signal after the AD conversion to the memory 62 (in the figure, “S conversion”). The memory 62 stores the pixel signal after the AD conversion output from the AD conversion circuit 61. The horizontal scanning circuit 70 sequentially scans the memories 62, and outputs the reset signal and the pixel signal after the AD conversion held in each of the memories 62 to the signal processing circuit 80. The signal processing circuit 80 subtracts the reset signal from the pixel signal, extracts only a signal corresponding to the amount of incident light, and outputs the extracted signal to the outside of the photoelectric conversion device.

At time t12f, the vertical scanning circuit 20 controls the control signal φCADD1n from high level to low level. The P-type MOS transistor M5a of the buffer circuit 30A is turned on, and the control signal φCADD1_O output from the buffer circuit 30A becomes high level (voltage VRESH). Since the voltage VRESH is supplied to the gate of the first capacitance addition transistor M2a, the first capacitance addition transistor M2a is turned on, and the input node FD is reset to a voltage (reset voltage) of a reset level corresponding to the voltage VDD.

At time t13f, the vertical scanning circuit 20 controls the control signal φSEL_O from high level to low level. The selection transistor M4 of the unit pixel 11 is turned off, the amplification transistor M3 of the unit pixel 11 is disconnected from the column signal line 13, and the reading of the signals of the unit pixels 11 of the two rows to be read simultaneously ends. As described above, in the case of driving for the high-gain high illuminance, low level of the control signal φCADD1_O is switched between the voltages VRESL0 and VRESL1.

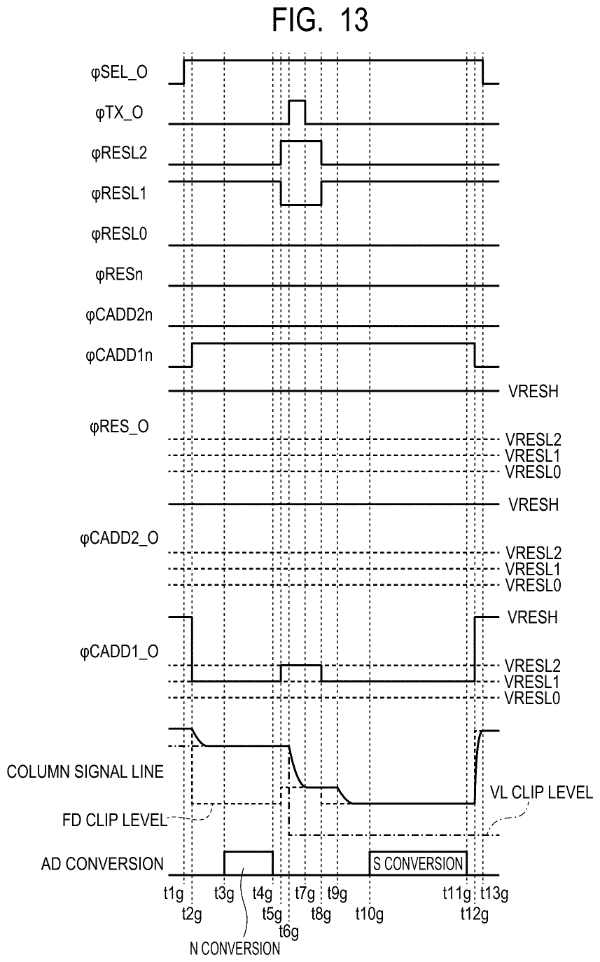

Next, a high-gain low illuminance driving mode of the photoelectric conversion device will be described with reference to FIG. 13. FIG. 13 is a timing chart illustrating an operation example of the photoelectric conversion device in the high-gain low illuminance driving mode according to the present embodiment. The high-gain low illuminance driving mode is different from the high-gain high illuminance driving mode illustrated in FIG. 12 in that the FD clip level is increased, and the same processing is executed in other modes.

In the case of the high-gain low illuminance driving mode, immediately before time tlg illustrated in FIG. 13, the control signals φRESn, φCADD1n, and φCADD2n are at low level. Therefore, the control signals φRES_O, φCADD1_O, and φCADD2_O output from the buffer circuit 30A become high level (voltage VRESH). Then, the voltage VRESH is supplied to the gates of the reset transistor M2, the first capacitance addition transistor M2a, and the second capacitance addition transistor M2b. The reset transistor M2, the first capacitance addition transistor M2a, and the second capacitance addition transistor M2b are turned on, and the input node FD (Cfd+C1+C2) is reset to a voltage (reset voltage) of a reset level corresponding to the voltage VDD.

At time t1g illustrated in FIG. 13, the vertical scanning circuit 20 controls the control signal φSEL_O from low level to high level for the target unit pixel 11 (the unit pixels 11 of two rows) in the pixel unit 10. The selection transistor M4 of the target unit pixel 11 is turned on, and the amplification transistor M3 of the target unit pixel 11 is connected to the column signal line 13 via the selection transistor M4. As a result, a bias current is supplied from the current source 50 to the amplification transistor M3 via the column signal line 13 and the selection transistor M4, and a reset signal corresponding to the reset voltage of the input node FD is output to the column signal line 13 via the selection transistor M4. The readout of the reset signal is started for the unit pixels 11 of the two rows simultaneously read out.

At time t2g, the vertical scanning circuit 20 controls the control signal φCADD1n from low level to high level. The N-type MOS transistor M6a of the buffer circuit 30A is turned on, and the control signal φCADD1_O output from the buffer circuit 30A becomes low level. At this time, the control signals φRESL0 and φRESL2 are at low level and the control signal φRESL1 is at high level, and the transistors M7 and M9 of the buffer circuit 30A are turned off and the transistor M8 is turned on. A voltage VRESL1 (for example, 0.6 V) is supplied to the gate of the first capacitance addition transistor M2a as a control signal φCADD1_O via the transistor M8. The first capacitance addition transistor M2a of the unit pixel 11 is turned off, and the input node FD is disconnected from the power supply (voltage VDD) and enters a floating state. The first capacitance addition transistor M2a is turned off, and the input node FD becomes the capacitance Cfd (capacitance “small”). The gain in the charge-voltage conversion becomes “high gain”. As compared with the case of the “medium gain”, the amplitude of the signal at the input node FD is easily limited. However, since the amplitude of the signal of the same charge amount becomes large, the noise of the amplification transistor M3 and the noise due to the AD conversion become relatively smaller, and the S/N ratio with respect to the low illuminance signal is improved.

Here, a state is illustrated in which high illuminance light is incident on the unit pixel 11, the charge that can be accumulated in the photoelectric conversion element PD is saturated, and the charge overflows from the photoelectric conversion element PD to the input node FD. Since the charge overflows to the input node FD, the voltage of the column signal line 13 decreases. During the readout period of the reset signal (from time t2g to time t6g), the VL clip level is higher than the FD clip level, and the voltage of the column signal line 13 stops decreasing at the VL clip level.

From time t3g to time t4g, the AD conversion circuit 61 performs AD conversion of the reset signal, and outputs the reset signal after the AD conversion to the memory 62 (“N conversion” in the figure). The memory 62 stores the reset signal after the AD conversion output from the AD conversion circuit 61.

At time t5g, the vertical scanning circuit 20 controls the control signal φRESL1 from high level to low level, and controls the control signal φRESL2 from low level to high level. The transistor M8 of the buffer circuit 30A is turned off, and the transistor M9 is turned on. The voltage VRESL2 (for example, 1.2 V) is supplied to the gate of the first capacitance addition transistor M2a of the unit pixel 11 as the control signal φCADD1_O via the transistor M9. The first capacitance addition transistor M2a functions as a clip transistor that limits the amplitude of the pixel signal at the FD clip level according to the gate voltage (for example, 1.2 V). The FD clip level is determined by the gate voltage of the first capacitance addition transistor M2a, and the FD clip level also rises as the voltage of the control signal φCADD1_O rises from the voltage VRESL1 (for example, 0.6 V) to the voltage VRESL2 (for example, 1.2 V).

At time t6g, the column signal line clip circuit 40 lowers the VL clip level than the FD clip level. At the same time tog, the vertical scanning circuit 20 controls the control signal φTX_O from low level to high level. The transfer transistor M1 of the unit pixel 11 is turned on, and the charge accumulated in the photoelectric conversion element PD is transferred to the input node FD. The transferred charge is further added to the charge already overflowing from the photoelectric conversion element PD to the input node FD, and the voltage of the input node FD further decreases. When the voltage of the input node FD decreases, the first capacitance addition transistor M2a is temporarily turned on, and the voltage of the input node FD is limited to the FD clip level based on the voltage VRESL2. Further, the VL clip level is controlled to be lower than the FD clip level, and the voltage of the column signal line 13 is also limited to the FD clip level.

At time t7g, the vertical scanning circuit 20 controls the control signal φTX_O from high level to low level. The transfer transistor M1 of the unit pixel 11 is turned off, and the transfer of the charge from the photoelectric conversion element PD to the input node FD is stopped.

At time t8g, the vertical scanning circuit 20 controls the control signal φRESL2 from high level to low level, and controls the control signal φRESL1 from low level to high level. The transistor M9 of the buffer circuit 30A is turned off, and the transistor M8 is turned on. A voltage VRESL1 (for example, 0.6 V) is supplied to the gate of the first capacitance addition transistor M2a of the unit pixel 11 as the control signal φCADD1_O via the transistor M8. The first capacitance addition transistor M2a functions as a clip transistor that limits the amplitude of the pixel signal at the FD clip level according to the gate voltage (for example, 0.6 V). The FD clip level is determined by the gate voltage of the first capacitance addition transistor M2a, and the FD clip level also decreases as the voltage of the control signal φCADD1_O decreases from the voltage VRESL2 (for example, 1.2 V) to the voltage VRESL1 (for example, 0.6 V). At this time, the charge of the input node FD is already discharged to the power supply (voltage VDD), and the voltage of the column signal line 13 does not change significantly.

At time t9g, the photoelectric conversion element PD becomes saturated, and the charge starts to overflow from the photoelectric conversion element PD to the input node FD again. Then, the voltages of the input node FD and the column signal line 13 start to decrease, and the decrease of the voltages of the input node FD and the column signal line 13 stops at the FD clip level based on the voltage VRESL1. An amount of the voltage drop of the column signal line 13 is determined by the voltage difference between the voltage VRES2 and the voltage VRESL1. When the illuminance is not high such that the charge overflows to the input node FD again immediately after the transfer of the charge, the amplitude of the column signal line 13 is limited at the FD clip level based on the voltage VRESL2.

From time t10g to time t11g, the AD conversion circuit 61 performs AD conversion of the pixel signal and outputs the pixel signal after the AD conversion to the memory 62 (in the figure, “S conversion”). The memory 62 stores the pixel signal after the AD conversion output from the AD conversion circuit 61. The horizontal scanning circuit 70 sequentially scans the memories 62, and outputs the reset signal and the pixel signal after the AD conversion held in each of the memories 62 to the signal processing circuit 80. The signal processing circuit 80 subtracts the reset signal from the pixel signal and outputs a signal corresponding to the amount of incident light to the outside of the photoelectric conversion device.

At time t12g, the vertical scanning circuit 20 controls the control signal φCADD1n from high level to low level. The P-type MOS transistor M5a of the buffer circuit 30A is turned on, and the control signal φCADD1_O output from the buffer circuit 30A becomes high level (voltage VRESH). The voltage VRESH is supplied to the gate of the first capacitance addition transistor M2a, the first capacitance addition transistor M2a is turned on, and the input node FD is reset to a voltage (reset voltage) of a reset level corresponding to the voltage VDD.

At time t13g, the vertical scanning circuit 20 controls the control signal φSEL_O from high level to low level. The selection transistor M4 of the unit pixel 11 is turned off, the amplification transistor M3 of the unit pixel 11 is disconnected from the column signal line 13, and the reading of the signals of the unit pixels 11 of the two rows to be read simultaneously ends. As described above, in the case of driving for the high-gain low illuminance, low level of the control signal φCADD1_O is switched between the voltages VRESL1 and VRESL2.

As described above, even in the high gain state in which the capacitance of the input node FD is not added, it is possible to prevent the influence of the fluctuation of the pixel signal due to the overflow of the charge from the photoelectric conversion element PD after the charge transfer from degrading in the low illuminance driving mode.

In the photoelectric conversion device according to the second embodiment, the reset transistor M2, the first capacitance addition transistor M2a, or the second capacitance addition transistor M2b selectively operates as a clip transistor. The photoelectric conversion device can suppress image quality degradation while suppressing crosstalk.

### Third Embodiment

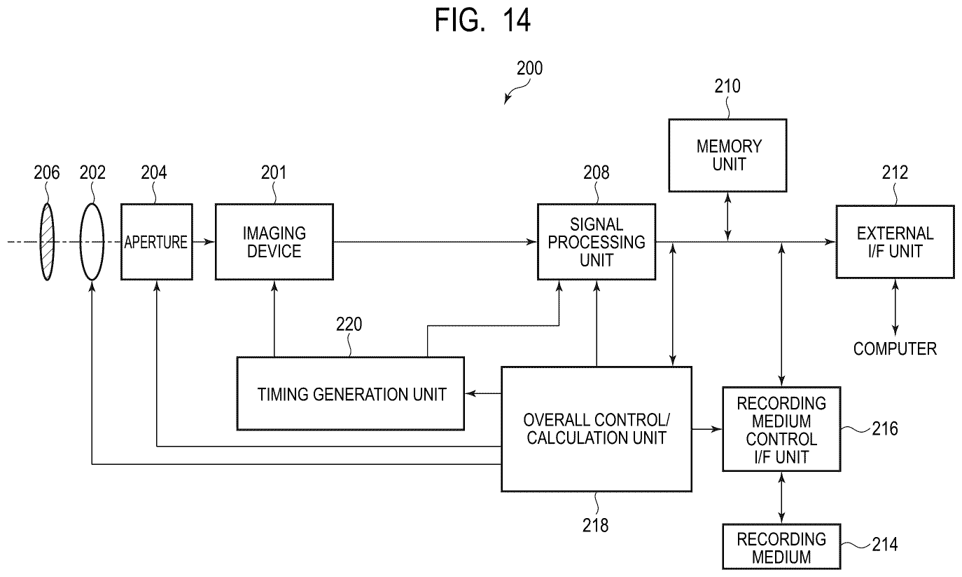

An imaging system according to a third embodiment of the present invention will be described with reference to FIG. 14. FIG. 14 is a block diagram illustrating a schematic configuration of an imaging system according to the present embodiment.

The photoelectric conversion devices described in the first and second embodiments are applicable to various imaging systems. Examples of applicable imaging systems include a digital still camera, a digital camcorder, a monitoring camera, a copier, a fax, a mobile phone, an on-board camera, an observation satellite, and the like. A camera module including an optical system such as a lens and an imaging device is also included in the imaging system. FIG. 14 exemplifies a block diagram of a digital still camera as one of these.

The imaging system 200 illustrated in FIG. 14 includes an imaging device 201, a lens 202 that forms an optical image of a subject on the imaging device 201, an aperture 204 that changes the amount of light passing through the lens 202, and a barrier 206 that protects the lens 202. The lens 202 and the aperture 204 are optical systems that focus light onto the imaging device 201. The imaging device 201 is the photoelectric conversion device described in any of the first to second embodiments, and converts an optical image formed by the lens 202 into image data.

The imaging system 200 also includes a signal processing unit 208 that processes an output signal output from the imaging device 201. The signal processing unit 208 generates image data from the digital signal output from the imaging device 201. Further, the signal processing unit 208 performs various corrections and compressions as necessary and outputs image data. The imaging device 201 may include an AD conversion unit that generates a digital signal to be processed by the signal processing unit 208. The AD conversion unit may be formed on a semiconductor layer (semiconductor substrate) on which the photoelectric conversion unit of the imaging device 201 is formed, or may be formed on a semiconductor substrate different from the semiconductor layer on which the photoelectric conversion unit of the imaging device 201 is formed. The signal processing unit 208 may be formed on the same semiconductor substrate as the imaging device 201.

The imaging system 200 further includes a memory unit 210 for temporarily storing image data, and an external interface unit (external I/F unit) 212 for communicating with an external computer or the like. Further, the imaging system 200 includes a recording medium 214 such as a semiconductor memory for recording or reading imaging data, and a recording medium control interface unit (recording medium control I/F unit) 216 for performing recording or reading on the recording medium 214. Note that the recording medium 214 may be built in the imaging system 200 or may be detachable.

The imaging system 200 further includes an overall control/calculation unit 218 that controls various calculations and the entire digital still camera, and a timing generation unit 220 that outputs various timing signals to the imaging device 201 and the signal processing unit 208. Here, the timing signal or the like may be input from the outside, and the imaging system 200 may include at least the imaging device 201 and the signal processing unit 208 that processes the output signal output from the imaging device 201.

The imaging device 201 outputs the imaging signal to the signal processing unit 208. The signal processing unit 208 performs predetermined signal processing on the imaging signal output from the imaging device 201, and outputs image data. The signal processing unit 208 generates an image using the imaging signal.

As described above, according to the present embodiment, it is possible to realize an imaging system to which the photoelectric conversion device according to the first or second embodiment is applied.

### Fourth Embodiment

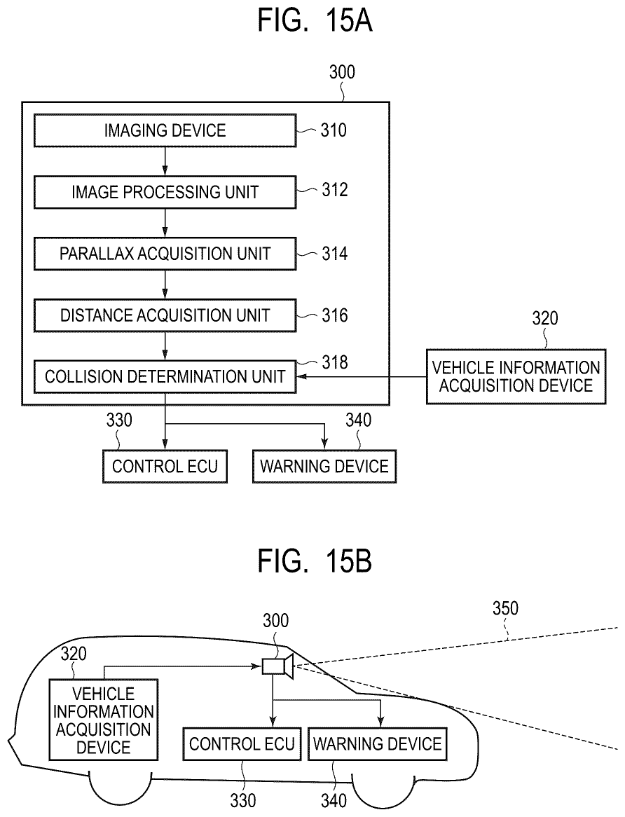

An imaging system and movable body according to a fourth embodiment of the present invention will be described with reference to FIGS. 15A and 15B. FIGS. 15A and 15B are diagrams illustrating configurations of the imaging system and movable body according to the present embodiment.

FIG. 15A illustrates an example of an imaging system related to an in-vehicle camera. The imaging system 300 includes an imaging device 310. The imaging device 310 is the photoelectric conversion device according to any of the first to second embodiments. The imaging system 300 includes an image processing unit 312 that performs image processing on a plurality of pieces of image data acquired by the imaging device 310, and a parallax acquisition unit 314 that calculates parallax (phase difference of parallax images) from the pieces of image data acquired by the imaging system 300. In addition, the imaging system 300 includes a distance acquisition unit 316 that calculates a distance to the target object based on the calculated parallax, and a collision determination unit 318 that determines whether there is a collision possibility based on the calculated distance. Here, the parallax acquisition unit 314 and the distance acquisition unit 316 are examples of a distance information acquisition unit that acquires distance information to an object. That is, the distance information is information related to a parallax, a defocus amount, a distance to an object, and the like. The collision determination unit 318 may determine the collision possibility using any of these pieces of distance information. The distance information acquisition unit may be realized by dedicatedly designed hardware or may be realized by a software module. Further, it may be realized by FPGA (Field Programmable Gate Array), ASIC (Application Specific Integrated circuit), or the like, or may be realized by a combination thereof.

The imaging system 300 is connected to the vehicle information acquisition device 320, and can acquire vehicle information such as a vehicle speed, a yaw rate, and a steering angle. Further, the imaging system 300 is connected to a control ECU 330 which is a control device that outputs a control signal for generating a braking force to the vehicle based on the determination result of the collision determination unit 318. The imaging system 300 is also connected to a warning device 340 that issues a warning to the driver based on the determination result of the collision determination unit 318. For example, when the determination result of the collision determination unit 318 indicates that the possibility of collision is high, the control ECU 330 performs vehicle control to avoid collision and reduce damage by, for example, applying a brake, returning an accelerator, or suppressing engine output. The warning device 340 gives a warning to the user by sounding a warning such as a sound, displaying warning information on a screen of a car navigation system or the like, giving vibration to a seat belt or a steering wheel, or the like.

In the present embodiment, the surroundings of the vehicle, for example, the front or the rear is imaged by the imaging system 300. FIG. 15B illustrates an imaging system in the case of imaging the front of the vehicle (imaging range 350). The vehicle information acquisition device 320 sends an instruction to the imaging system 300 or the imaging device 310. With such a configuration, the accuracy of distance measurement can be further improved.

Although an example in which control is performed so as not to collide with another vehicle has been described above, the present invention is also applicable to control in which automatic driving is performed so as to follow another vehicle, control in which automatic driving is performed so as not to protrude from a lane, and the like. Further, the imaging system is not limited to a vehicle such as an own vehicle, and can be applied to, for example, movable body (mobile device) of a ship, an aircraft, an industrial robot, or the like. In addition, the present invention is not limited to movable body, and can be widely applied to devices using object recognition, such as an intelligent traffic system (ITS).

### Fifth Embodiment

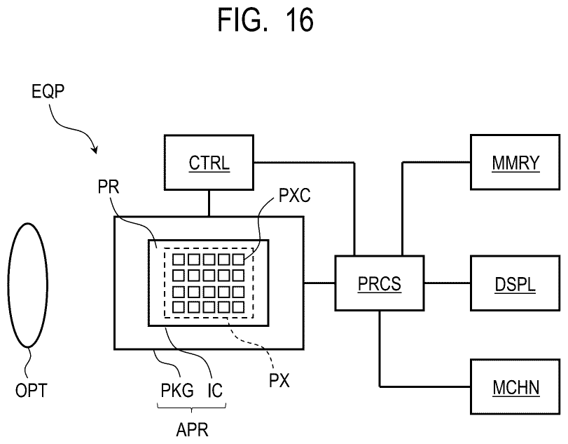

An equipment according to a fifth embodiment of the present invention will be described with reference to FIG. 16. FIG. 16 is a block diagram illustrating a schematic configuration of an equipment according to the present embodiment.

FIG. 16 is a schematic diagram illustrating an equipment EQP including the photoelectric conversion device APR. The photoelectric conversion device APR has the function of the photoelectric conversion device according to any of the first to second embodiments. All or part of the photoelectric conversion device APR is a semiconductor device IC. The photoelectric conversion device APR of the present example can be used as, for example, an image sensor, an AF (Auto Focus) sensor, a photometric sensor, or a distance measuring sensor. The semiconductor device IC has a pixel area PX in which pixel circuits PXC including photoelectric conversion units are arranged in a matrix. The semiconductor device IC may have a peripheral area PR around the pixel area PX. A circuit other than the pixel circuit can be disposed in the peripheral area PR.

The photoelectric conversion device APR may have a structure (chip stacked structure) in which a first semiconductor chip provided with a plurality of photoelectric conversion units and a second semiconductor chip provided with a peripheral circuit are stacked. Each of the peripheral circuits in the second semiconductor chip may be a column circuit corresponding to a pixel column of the first semiconductor chip. The peripheral circuits in the second semiconductor chip may be matrix circuits corresponding to pixels or pixel blocks in the first semiconductor chip. As the connection between the first semiconductor chip and the second semiconductor chip, a through silicon via (TSV), an inter-chip wiring by direct bonding of a conductor such as copper, a connection by a micro bump between chips, a connection by wire bonding, or the like can be applied.

The photoelectric conversion device APR may include a package PKG that accommodates the semiconductor device IC in addition to the semiconductor device IC. The package PKG can include a base to which the semiconductor device IC is fixed, a lid such as glass facing the semiconductor device IC, and a connection member such as a bonding wire or a bump for connecting a terminal provided in the base and a terminal provided in the semiconductor device IC.

The equipment EQP may further include at least one of an optical device OPT, a control device CTRL, a processing device PRCS, a display device DSPL, a storage device MMRY, and a mechanical device MCHN. The optical device OPT corresponds to the photoelectric conversion device APR, and is, for example, a lens, a shutter, or a mirror. The control device CTRL controls the photoelectric conversion device APR, and is, for example, a semiconductor device such as an ASIC. The processing device PRCS processes a signal output from the photoelectric conversion device APR, and constitutes an analog front end (AFE) or a digital front end (DFE). The processing unit PRCS is a semiconductor device such as a central processing unit (CPU) or an application specific integrated circuit (ASIC). The display device DSPL is an EL display device or a liquid crystal display device that displays information (image) obtained by the photoelectric conversion device APR. The storage device MMRY is a magnetic device or a semiconductor device that stores information (image) obtained by the photoelectric conversion device APR. The storage device MMRY is a volatile memory such as an SRAM or a DRAM, or a nonvolatile memory such as a flash memory or a hard disk drive. The mechanical device MCHN includes a movable portion or a propulsion portion such as a motor or an engine. In the equipment EQP, a signal output from the photoelectric conversion device APR is displayed on the display device DSPL or transmitted to the outside by a communication device (not illustrated) included in the equipment EQP. Therefore, it is preferable that the equipment EQP further include a storage device MMRY and a processing device PRCS separately from the storage circuit unit and the arithmetic circuit unit included in the photoelectric conversion device APR.

The equipment EQP illustrated in FIG. 16 can be an electronic device such as an information terminal (for example, a smartphone or a wearable terminal) or a camera (for example, an interchangeable lens camera, a compact camera, a video camera, and a monitoring camera) having a photographing function. The mechanical device MCHN in the camera can drive components of the optical device OPT for zooming, focusing, and shutter operation. The equipment EQP may be a vehicle, a ship, or a transportation device (movable body) such as flying object. The equipment EQP may be a medical device such as an endoscope or a CT scanner.

The mechanical device MCHN in the transport device can be used as a mobile device. The equipment EQP as a transport device is suitable for transporting the photoelectric conversion device APR and assisting and/or automating operation (manipulation) by an imaging function. The processing device PRCS for assisting and/or automating driving (manipulation) can perform processing for operating the mechanical device MCHN as a moving device based on information obtained by the photoelectric conversion device APR.

The photoelectric conversion device APR according to the present embodiment can provide a high value to a designer, a manufacturer, a seller, a purchaser, and/or a user thereof. Therefore, when the photoelectric conversion device APR is mounted on the equipment EQP, the value of the equipment EQP can also be increased. Therefore, in manufacturing and selling the equipment EQP, it is advantageous to determine the mounting of the photoelectric conversion device APR of the present embodiment on the equipment EQP in order to increase the value of the equipment EQP.

### Modified Embodiments

The present invention is not limited to the above-described embodiment, and various modifications are possible. For example, an example in which a part of the configuration of any of the embodiments is added to another embodiment or an example in which a part of the configuration of another embodiment is replaced with another embodiment is also an embodiment of the present invention.

For example, the photoelectric conversion device according to the second embodiment has been described as including the first capacitance addition transistor M2a and the second capacitance addition transistor M2b as transistors for adding capacitance to the input node FD, but the photoelectric conversion device is not limited to this. For example, the photoelectric conversion device may include only the first capacitance addition transistor M2a and may not include the second capacitance addition transistor M2b among the first capacitance addition transistor M2a and the second capacitance addition transistor M2b. In this case, the reset transistor M2 or the first capacitance addition transistor M2a selectively operates as a clip transistor.

In addition, the switching of low level of the control signal φRES_O between the high illuminance driving mode and the low illuminance driving mode is performed using three values of the voltage VRESL0, the voltage VRESL1, and the voltage VRESL2, but the switching is not limited thereto. When the FD clip level in the charge transfer period is changed to be higher than that in the high illuminance driving mode in the low illuminance driving mode, the FD clip level in the period other than the charge transfer period may be increased to obtain the effect.

Further, although the transfer transistor M1 is turned on after the FD clip level is raised, the present invention is not limited thereto, and for example, the FD clip level may be raised after the transfer transistor M1 is turned on. By providing a period for discharging the charge at a high FD clip level at least after transferring the charge of the photoelectric conversion element PD to the input node FD and before performing the AD conversion, the effect of the amplitude limitation can be obtained.

In addition, although an example in which the reset transistor M2 also operates as a clip transistor has been described, the present invention is not limited thereto. For example, the reset transistor M2 and the clipping transistor may be separately provided without providing the clipping function to the reset transistor M2.

According to the present invention, it is possible to realize the photoelectric conversion device and a control method thereof capable of suppressing image quality degradation while suppressing crosstalk.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-029691, filed Feb. 29, 2024, which is hereby incorporated by reference herein in its entirety.

What is claimed is:

1. A photoelectric conversion device comprising:
a plurality of pixels, each configured to include a photoelectric conversion unit that accumulates a charge according to incident light, an input node that holds the charge, a transfer transistor that transfers the charge from the photoelectric conversion unit to the input node, an amplification transistor that outputs a pixel signal based on the charge of the input node, and a clip transistor that clips voltage of the input node; and
an AD conversion circuit configured to perform AD conversion of the pixel signal at the time of resetting the input node in a first period and perform AD conversion of the pixel signal based on the charge corresponding to the incident light in a second period,
wherein the clip transistor is switchable between a first operation and a second operation,
wherein in the first operation, a first voltage is supplied to a gate of the clip transistor in the first period and the second period, and a second voltage higher than the first voltage is supplied to the gate of the clip transistor in a transfer period in which the transfer transistor is on after the first period and before the second period, and
wherein in the second operation, a third voltage higher than the first voltage is supplied to the gate of the clip transistor in the first period and the second period, and a fourth voltage higher than the second voltage and the third voltage is supplied to the gate of the clip transistor in the transfer period.

2. The photoelectric conversion device according to claim 1, wherein a difference between the first voltage and the second voltage corresponds to a difference between the third voltage and the fourth voltage.

3. The photoelectric conversion device according to claim 1, wherein the second voltage and the third voltage are the same.

4. The photoelectric conversion device according to claim 1, wherein a period in which the second voltage or the fourth voltage is supplied to the gate of the clip transistor is longer than the transfer period.

5. The photoelectric conversion device according to claim 1, wherein after the second voltage or the fourth voltage is supplied to the gate of the clip transistor, the transfer transistor is turned on, and after the transfer transistor is turned off, the first voltage or the third voltage is supplied to the gate of the clip transistor.

6. The photoelectric conversion device according to claim 1, wherein a period from when the transfer transistor is turned off to when the first voltage or the third voltage is supplied to the gate of the clip transistor is longer than a period from when the second voltage or the fourth voltage is supplied to the gate of the clip transistor to when the transfer transistor is turned on.

7. The photoelectric conversion device according to claim 1,
wherein the pixel includes a reset transistor configured to reset voltage of the input node, and
wherein the reset transistor operates as the clip transistor.

8. The photoelectric conversion device according to claim 7,
wherein a first main node of the reset transistor is connected to the input node, and
wherein a second main node of the reset transistor is connected to a power supply voltage line.

9. The photoelectric conversion device according to claim 1,
wherein the pixel includes a reset transistor and a first capacitance addition transistor capable of adding capacitance to the input node, and
wherein the reset transistor or the first capacitance addition transistor selectively operates as the clip transistor.

10. The photoelectric conversion device according to claim 9,
wherein a first main node of the first capacitance addition transistor is connected to the input node,
wherein a second main node of the first capacitance addition transistor is connected to a first main node of the reset transistor, and
wherein a second main node of the reset transistor is connected to a power supply voltage line.

11. The photoelectric conversion device according to claim 9,
wherein the pixel further includes a second capacitance addition transistor capable of adding capacitance to the input node, and
wherein the reset transistor, the first capacitance addition transistor, or the second capacitance addition transistor selectively operates as the clip transistor.

12. The photoelectric conversion device according to claim 11,
wherein a first main node of the first capacitance addition transistor is connected to the input node,
wherein a second main node of the first capacitance addition transistor is connected to a first main node of the second capacitance addition transistor,
wherein a second main node of the second capacitance addition transistor is connected to a first main node of the reset transistor, and
wherein a second main node of the reset transistor is connected to a power supply voltage line.

13. The photoelectric conversion device according to claim 1, wherein the clip transistor operates in the first operation when the incident light has high illuminance, and operates in the second operation when the incident light has low illuminance.

14. The photoelectric conversion device according to claim 1,
wherein the plurality of pixels are arranged in a plurality of rows and a plurality of columns,
wherein a plurality of column signal lines are arranged for each column of the pixel, and
wherein the AD conversion circuit simultaneously performs AD conversion of the pixel signals output from the plurality of pixels in the plurality of rows.

15. The photoelectric conversion device according to claim 14, further comprising a column signal line clip circuit configured to limit an amplitude of the pixel signal transmitted to the column signal line.

16. The photoelectric conversion device according to claim 15,
wherein in the first period, a clip level of the clip transistor is lower than a clip level of the column signal line clip circuit, and
wherein in the transfer period and the second period, the clip level of the clip transistor is higher than the clip level of the column signal line clip circuit.

17. An imaging system comprising:
the photoelectric conversion device according to claim 1, and
a signal processing device configured to process a signal output from the photoelectric conversion device.

18. A movable body comprising:
the photoelectric conversion device according to claim 1;
a distance information acquiring unit configured to acquire distance information to an object from a parallax image based on a signal output from the photoelectric conversion device; and,
a control unit configured to control the movable body based on the distance information.

19. An equipment comprising:
the photoelectric conversion device according to claim 1; and
at least one of the following:
an optical device corresponding to the photoelectric conversion device;
a control device configured to control the photoelectric conversion device;
a processing device configured to process a signal output from the photoelectric conversion device;
a mechanical device configured to be controlled based on information obtained by the photoelectric conversion device;
a display device configured to display information obtained by the photoelectric conversion device; and
a storage device configured to store information obtained by the photoelectric conversion device.

20. A control method of a photoelectric conversion device,
wherein the photoelectric conversion device includes:
a plurality of pixels, each configured to include a photoelectric conversion unit that accumulates a charge according to incident light, an input node that holds the charge, a transfer transistor that transfers the charge from the photoelectric conversion unit to the input node, an amplification transistor that outputs a pixel signal based on the charge of the input node, and a clip transistor that clips voltage of the input node; and
an AD conversion circuit configured to perform AD conversion of the pixel signal at the time of resetting the input node in a first period and perform AD conversion of the pixel signal based on the charge corresponding to the incident light in a second period,
wherein the control method comprises switching between a first operation and a second operation,
wherein in the first operation, a first voltage is supplied to a gate of the clip transistor in the first period and the second period, and a second voltage higher than the first voltage is supplied to the gate of the clip transistor in a transfer period in which the transfer transistor is on after the first period and before the second period, and
wherein in the second operation, a third voltage higher than the first voltage is supplied to the gate of the clip transistor in the first period and the second period, and a fourth voltage higher than the second voltage and the third voltage is supplied to the gate of the clip transistor in the transfer period.
